(19) United States
(12) Patent Application Publication
(10) Pub. No.: US 2004/0201764 A1
(43) Pub. Date: Oct. 14, 2004

(54) DUAL MODE IMAGE SHOOTING APPARATUS WITH STILL IMAGE AND MOTION VIDEO IMAGE RECORDING AND REPRODUCTION

(76) Inventors: TSUTOMU HONDA, OSAKA (JP); TOUGO TERAMOTO, WAKAYAMA-SHI (JP); HIROAKI KUBO, OSAKA (JP); GEN SASAKI, OSAKA (JP); KIYOSHI SEIGENJI, OSAKA (JP); HIDEKI NAGATA, OSAKA (JP); SHIGETO OHMORI, OSAKA (JP); TOSHIHIRO HAMAMURA, OSAKA (JP)

Correspondence Address: BURNS DOANE SWECKER & MATHIS L L P, POST OFFICE BOX 1404, ALEXANDRIA, VA, 22313-1404, US

(21) Appl. No.: 08/666,653

(22) Filed: Jun. 18, 1996

(30) Foreign Application Priority Data
Jun. 21, 1995 (JP) H7-154260
Jun. 21, 1995 (JP) H7-154261
Jun. 21, 1995 (JP) H7-154636
Jun. 21, 1995 (JP) H7-154688
Jun. 22, 1995 (JP) H7-155653
Jun. 23, 1995 (JP) H7-157284
Jun. 23, 1995 (JP) H7-157668
Jun. 23, 1995 (JP) H7-157713

(51) Int. Cl. H04N 5/222; H04N 5/225

(52) U.S. Cl. 348/333.01

(57) ABSTRACT

An image shooting camera is provided with a silver salt picture shooting section, a video signal recording section, an information provider, an information recording section and an index data recording section. The provider outputs an individual identification number and a frame number of a silver salt photosensitive medium used as a recording medium of the silver salt picture shooting section. The numbers outputted from the provider are recorded by the information recording section. The index data recording section records index data including the numbers through the video signal recording section.

### BACKGROUND OF THE INVENTION

1. Field of the Invention

The present invention relates to an image shooting apparatus, and particularly to an image shooting apparatus which is capable of recording a silver salt (silver halide) picture and recording an image signal.

2. Description of the Prior Art

As a conventional example, an article in the June, 1994 issue of the “Photographic Industries” magazine, pages 12 to 15, describes an image recording apparatus which is capable of both recording a silver salt picture and recording an image signal.

To achieve a more advanced versatility, an image shooting apparatus is desired to have, in addition to the above described conventional functions, a various modes of operation, such as a mode in which silver salt shooting and video movie shooting can be performed simultaneously, a mode for reproducing a video, a mode for shooting a still-picture video, an edit mode for editing information recorded on a silver salt film and other modes.

However, since such an image shooting apparatus has various and complicated functions, it is necessary to indicate on a display such as a viewfinder what operation is currently being performed and what are the current states of the items needed for editing, such as individual identification number, frame number, date, time, print aspect ratio, whether or not in process of movie recording, and other items, so that such information is notified to the user and recorded on a recording medium.

In this case, when still-image shooting is performed during video movie shooting, for example, the apparatus is expected to be capable of searching for still-picture shooting information during reproduction. Accordingly, in order for the user to recognize the existence of the still-picture on a recording medium, the apparatus is also expected to be capable of displaying the still-picture shooting information in a display unit.

In one conventional image shooting apparatus, reproduction conditions are changed at the recording by index data recorded in a data area of a recording medium so that a reproduced screen can be automatically changed from a normal screen to a wide screen according to the index data recorded in a data area secured in a recording medium.

However, in the conventional apparatus, reproduction conditions are changed according to the data from the data area indeed, but only to change the screen from the normal screen to the horizontally extended wide screen. Accordingly, even though it is possible to display a still picture in the display unit, it is not possible to display still-picture shooting information by use of the automatic normal/wide screen switching function.

Another conventional image shooting apparatus performs a date search, that is, it searches the data area for a turning point of date to reproduce the portion starting from the turning point for around 10 seconds for a searching purpose.

However, in the conventional apparatus, it is not possible to display still-picture shooting information by use of the function for searching for a turning point of date to reproduce the portion starting from the turning point for a while for a searching purpose.

To achieve information display, in a conventional video camera, the index data recorded in a data area secured on a recording medium is recorded in one portion at the top of a DAT (Digital Audio Tape system) tape.

However, in this conventional camera, since the index data is placed in one portion at the top of a DAT tape, it is possible to efficiently retrieve shooting information indeed, but it is not possible to perform silver salt shooting, because a function as a still camera is not provided. Accordingly, even if the above described method is applied to an image shooting apparatus functioning as both a video camera and a still camera, it is not possible to record shooting information on a silver salt picture.

In such an image shooting apparatus which functions as both a still camera and a video camera, it is often necessary to confirm shooting records by contrasting still pictures and a video picture immediately or in a certain time lag after shooting. It is also necessary to record information representing a relationship between the still pictures and the video picture as a database after shooting.

As a conventional example, Japanese Laid-Open Utility Model No. S63-192773 and Japanese Laid-Open Patent No H5-75902 disclose an image shooting apparatus in which only frame numbers of a silver salt film are mixed as a character signal into an image signal. Moreover, Japanese Laid-Open Patent No. 3-27173 discloses a camera equipped with an electric display device functioning also as a viewfinder, in which only release viewing can be performed by use of the electric display device.

However, in the former image shooting apparatus, in order to cope with the case where a plurality of silver salt films are used simultaneously with one magnetic tape serving as a image recording medium, only frame numbers of a silver salt film is mixed as a character signal with an image signal, and the frame numbers are superimposed on the image signal when displayed. Accordingly, it is difficult to retrieve entries in the database and, in particular, to cope with the case where a silver salt film is exchanged at its midpoint leaving the remaining portion unused. Moreover, in the latter camera, since it does not have a function as a video camera, an image signal cannot be recorded.

### SUMMARY OF THE INVENTION

An object of the present invention is to provide an image shooting apparatus with a still camera which is provided with a function for displaying still-picture shooting information in a display unit when it is necessary to search a recording medium for still-picture shooting information during reproduction in the case where still-picture shooting is performed during video movie shooting.

Another object of the present invention is to provide an image shooting apparatus with a still camera in which shooting information of silver salt shooting is recorded in one place as index data.

Still another object of the present invention is to provide an image shooting apparatus functioning as both a still camera and a video camera, in which entries of a database can be easily retrieved.

To achieve the above object, one aspect of an image shooting apparatus of the present invention is provided with a silver salt picture shooting section having a silver salt picture recording function and a silver salt information recording function, a video picture shooting section, a video signal recording section for recording a video signal obtained by the video picture shooting section and video information on the recording medium, a video signal reproduction section for reproducing the video signal and video information from the recording medium, an electric display device for displaying the video picture and video information reproduced by the video signal reproduction section, a shooting information provider for outputting various items of information as to shooting, and an information input section for inputting the various items of information into the shooting information provider by the video signal recording section.

According to the above construction, it is possible to record silver salt information when a silver salt picture is recorded, whereas it is also possible to record video information when video signal is recorded. The silver salt information thus inputted during recording can be displayed on the electric display device. For example, when silver salt picture shooting is performed during video movie shooting, the thus shot image can be displayed as a still image during reproduction of the video, with reproduction conditions being varied in accordance with the data from the data area. Consequently, it is possible to observe an image of silver salt shooting before developing the image, by searching for, extracting and then reproducing data of the still image of the time when silver salt shooting was performed.

According to another feature of the present invention, the image shooting apparatus of the present invention is provided with a silver salt picture shooting section having a silver salt picture recording function and a silver salt information recording function, a video picture shooting section, a video signal recording section for recording a video signal obtained by the video picture shooting section and video information, a silver salt film individual identification number/frame number provider for outputting an individual identification number and a frame number of a silver salt film used as a recording medium for the silver salt picture shooting section, and an index data recording section provided separately from the video signal recording section for recording index data which is an aggregate of shooting information during silver salt shooting.

According to the above construction, it is possible to record silver salt information when a silver salt picture is recorded, whereas it is also possible to record video information when video signal is recorded. Since the silver salt information thus inputted during recording is recorded in the index data recording section, the silver salt information can easily be retrieved by searching the index data recording portion. Accordingly, it is not necessary to search a film or a recording medium from end to end in order to retrieve silver salt information.

According to still another feature of the present invention, the image shooting apparatus is provided with a silver salt picture shooting section including a silver salt picture recording means and a silver salt information recording means, a video signal recording section including a video signal recording means and a video information recording means, and a silver salt film individual identification number/frame number output means for outputting an individual identification number and a frame number to a silver salt film used as a recording medium of the silver salt picture shooting section.

According to the above construction, it is possible to record silver salt information when a silver salt picture is recorded, whereas it is also possible to record video information when video signal is recorded. Simultaneously with recording, a silver salt film individual identification number and a frame number are additionally inputted. This makes it possible to record the individual identification number on the silver salt film, so that images taken by the still camera can be observed as image signals immediately or in a certain time lag after shooting, and so that information representing relationships between the still pictures and the video picture can be recorded as a database after shooting. Further, in contrast to a conventional construction where frame numbers are superimposed on the image signal, the individual identification number and the frame number are recorded as an information signal into the image signal, so that entries in the database can be easily retrieved.

### BRIEF DESCRIPTION OF THE DRAWINGS

This and other objects and features of this invention will become clear from the following description, taken in conjunction with the preferred embodiments with reference to the accompanied drawings in which:

FIG. 1 is an outline construction diagram showing an embodiment of an image shooting apparatus of the present invention;

FIG. 2 is a schematic diagram showing the construction of the optical system of the image shooting apparatus;

FIG. 3 is a plan view showing the appearance of the apparatus;

FIG. 4 is a rear view showing the appearance of the apparatus;

FIG. 5 is a front view showing the appearance of the apparatus;

FIG. 6 is a bottom view showing the appearance of the apparatus;

FIG. 7 is a detail plan view of the operation indication unit employed in the apparatus;

FIG. 8A is a schematic diagram showing the construction of the pellicle mirror and the relay optical system in the apparatus;

FIG. 8B is a schematic diagram showing the construction of a conventional camera;

FIG. 9 is a detail diagram of the exposure area of a 135 film;

FIG. 10 is a detail diagram of the exposure area and the print size of a film according to another film system standard;

FIG. 11 is a detail diagram showing the CCD image sensor and an example of arrangement of the movie format and the silver salt film format according to another film system standard;

FIG. 12 is a detail diagram showing the CCD image sensor and another example of arrangement of the movie format and the silver salt film format according to another film system standard;

FIG. 13 is a detail diagram showing the CCD image sensor and still another example of arrangement of the movie format and the silver salt film format according to another film system standard;

FIG. 14 is a detail diagram showing the CCD image sensor and an example of arrangement of the movie format and the silver salt film format for a 135 film;

FIG. 15 is a detail diagram showing the CCD image sensor and an example of arrangement of the movie format and the silver salt film format for a Brownie film;

FIGS. 16A to 16C show screens, corresponding to the normal television, of the EVF unit in silver salt shooting mode;

FIGS. 17A to 17C show screens, corresponding to the wide-size television, of the EVF unit in silver salt shooting mode in said embodiment;

FIGS. 18A and 18B show screens of the wide-viewfinder display in silver salt shooting mode in said embodiment;

FIGS. 19A and 19B show screens, corresponding to the normal television, of the EVF unit in video shooting mode in said embodiment;

FIGS. 20A and 20B show screens, corresponding to the wide-size television, of the EVF unit in video shooting mode in said embodiment;

FIGS. 21A to 21C show screens, corresponding to the normal television, of the EVF unit in simultaneous shooting mode in said embodiment;

FIGS. 22A to 22C are continuation of FIG. 21;

FIGS. 23A to 23C show screens, corresponding to the wide-size television, of the EVF unit in simultaneous shooting mode in said embodiment;

FIGS. 24A to 24C are continuation of FIG. 23;

FIGS. 25A to 25C show examples of screens displayed during electronic zooming in said embodiment;

FIG. 26 is a continuation of FIG. 25;

FIG. 27 is a diagram showing a recording arrangement of the present invention;

FIG. 28 shows a state of the silver salt film extracted from the film cartridge;

FIGS. 29A and 29B show the data area on an 8 mm-format videocassette tape;

FIGS. 30A to 30C show examples of the screen in the cases where information is displayed on the screen in the form of characters in said embodiment;

FIG. 31 shows an example of the index screen in said embodiment;

FIGS. 32A and 32B are diagrams for explaining operation on the screen of EVF unit in said embodiment; and

FIG. 33 shows an example of creating index data on a tape-form recording medium in said embodiment.

### DESCRIPTION OF THE PREFERRED EMBODIMENTS

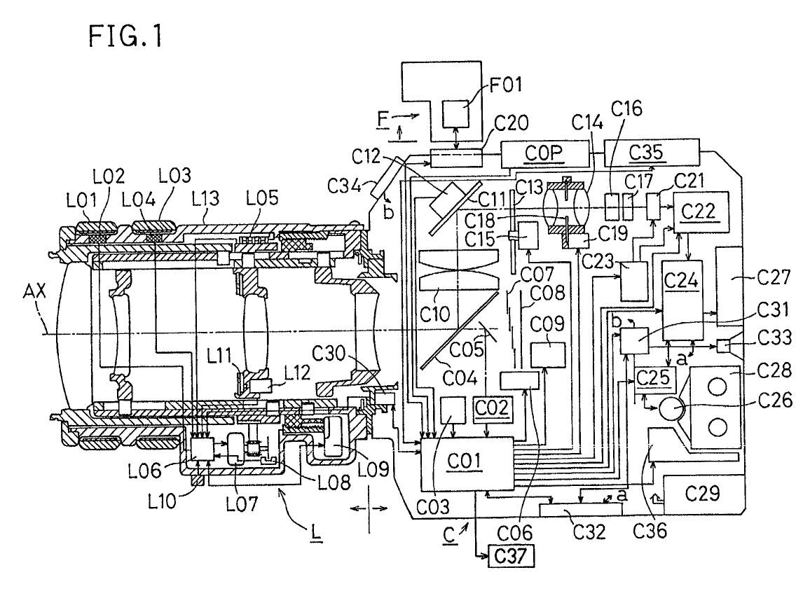

Hereinafter, an embodiment of the present invention will be described with reference to the drawings. FIG. 1 schematically shows the structure of the embodiment. As shown in FIG. 1, the image shooting apparatus according to the present embodiment includes a camera body C, a main lens L, and a lighting and flashing unit F (hereinafter referred to as “flash-and-light”). The video shooting optical system and the sliver salt (silver halide) shooting optical system, which will be described later, are formed of common structural members.

In the following description of the embodiment, for easier reference between the description and the drawings, the reference designations of the components of the camera body C begin with C, those of the main lens L begin with L, those of the flash-and-light F begin with F, and those of the operation unit C0P provided in the camera body C begin with C0P.

Although the main lens L and the flash-and-light L are constructed separately from the camera body C in this embodiment, the present invention includes a structure in which the camera body C and the main lens L, the camera body C and the flash-and-light F, or these three portions are formed as one unit. The video shooting optical system and the silver salt shooting optical system may be formed separately from each other.

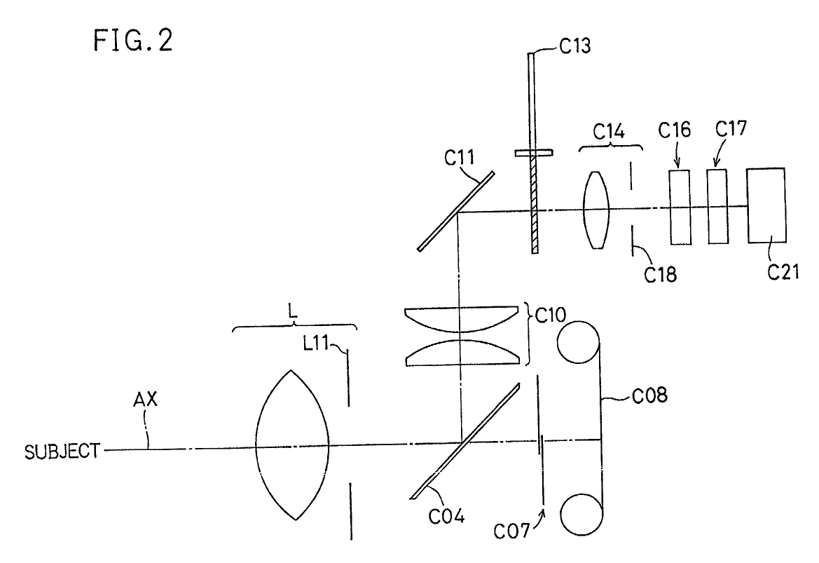

FIG. 2 schematically shows the structure of the optical system of this embodiment. In FIG. 2, light from a subject passes through the main lens L, and has its quantity controlled by a main lens aperture diaphragm L11. Then, the light is split by a pellicle mirror C04 into a first light path leading to a film C08 when a shutter C07 opens and a second light path branching off from the first light path in the pellicle mirror C04 and leading through a condenser lens C10, a reflecting mirror C11 and an ND filter C13 to a relay lens C14. AX represents an optical axis extending from the subject toward the main lens L.

The light coming from the subject and having been directed along the second light path toward the relay lens C14 has its quantity controlled by a relay aperture diaphragm C18, travels through an optical low-pass filter C16 and an infrared ray (IR) cut filter C17, and then reaches a CCD (charge coupled device) image sensor C21, which serves as a photoelectric converter. Although the CCD image sensor C21 shown in FIG. 2 is of a single-plate type, a CCD image sensor of a multiple-plate type may be used.

The first light path is a light path for still shooting by use of a silver salt film. The second light path is a light path for movie shooting by use of a video recording medium. As shown in FIG. 1, silver salt shooting sections C06 to C09 and video signal shooting sections C21 to C27 are provided in the camera body C.

First, the structure of the main lens L will be described below, with reference to FIG. 1. L01 and L03 represent operation rings manually operated by the user. L01 represents a focusing operation ring and L03 represents a zooming operation ring. L13 represents a stationary barrel. L02 and L04 represent operation ring condition detectors which detect rotation of the operation rings L01 and L03, respectively. Typically, the detectors L02 and L04 comprise encoders.

L05 represents a focal length detector for detecting the focal length of the main lens L. L06 represents a lens microcomputer serving as a operational controller of the main lens L. L07 represents a zooming motor for zooming the main lens L. L0B represents a zooming motor monitor for detecting the rotation condition of the zooming motor L07. The monitor L08 comprises, for example, a photo-interrupter.

L09 represents a focusing motor for focusing the main lens L. L10 represents an AF/MF switching button for switching between automatic focusing and manual focusing. L11 represents a main lens aperture diaphragm. L12 represents a main lens aperture diaphragm controller. The main lens aperture diaphragm controller L12 includes a stepping motor for actuating the aperture diaphragm, and an aperture condition detector.

The focusing and zooming operation rings L01 and L03 are fitted on the peripheral surface of the stationary barrel L13 to be rotatable about the optical axis of the main lens L. Rotation of the focusing operation ring L01 activates power focusing. Rotation of the zooming operation ring L03 activates power zooming.

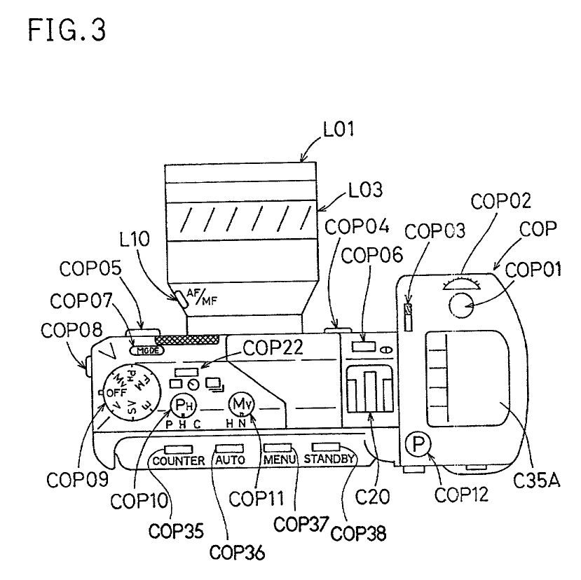

Next, the structure of the camera body C will be described below. C01 represents a camera microcomputer serving as a operational controller of the camera body C. The camera microcomputer C01 exchanges information with the main lens L through data/power-supply contacts C30. As to the flash-and-light F, the camera microcomputer C01 exchanges information with the operational controller F01 of the flash-and-light F through contacts provided in an accessory shoe C20. The external view of the shoe C20 for attaching an external flash-and-light is shown in FIG. 3.

C05 represents an AF auxiliary mirror provided at the rear of the above-mentioned pellicle mirror C04. The subject light having passed through the main lens L is split by the pellicle mirror C04, and then travels along the first light path until further split by the AF auxiliary mirror C05 and directed to a focus detector C02. The focus detector C02 transmits focus information to the camera microcomputer C0. The focus information processed by the camera microcomputer C01 is transmitted to the lens microcomputer L06, which then issues a command for driving the focusing motor L09 to perform focusing.

C06 represents a shutter driver which opens and closes the shutter C07 in response to a command from the camera microcomputer C01. More specifically, the camera microcomputer C01 issues a command signal to the shutter driver C06 based on information from the operation unit C0P, a brightness detector C12 and others. C08 represents a film, whose surface is exposed to the light having travelled along the first light path through the opening created by the releasing of the shutter C07 so that a latent image of the subject is formed thereupon. C09 represents a film advancing controller for driving an incorporated motor to wind and rewind the film.

The light split by the pellicle mirror C04 and having travelled along the second light path is directed through the condenser lens C10, the reflecting mirror C11, the ND filter C13, a relay optical system including the relay lens C14, the optical low-pass filter C16 and the IR cut filter C17 to the CCD image sensor C21. The reflecting mirror C11 is partially semitransparent, so that part of the light is admitted to the brightness detector C12 through the semi-transparent portion for the detection of the brightness of the subject.

C15 represents an ND filter controller for controlling the ND filter C13 based on ND density information set by the camera microcomputer C01 based on the difference in sensitivity between the film C08 loaded in the camera body C and the CCD image sensor C21 and based on the brightness of the subject detected by the brightness detector C12. The relay optical system is provided with a relay aperture diaphragm C18, which is controlled by a relay aperture diaphragm controller Cl9 so that the quantity of the light directed to the image sensor C21 is controlled.

The CCD image sensor C21 converts the light from the subject into an electric signal based on driving pulses generated by a CCD driving pulse generator C23 in response to a command from the camera microcomputer C01. The photoelectrically converted electric signal is transmitted to an image forming processor C22, subjected to analog processing such as sampling, analog/digital (A/D) converted, and then transmitted to an image processor C24.

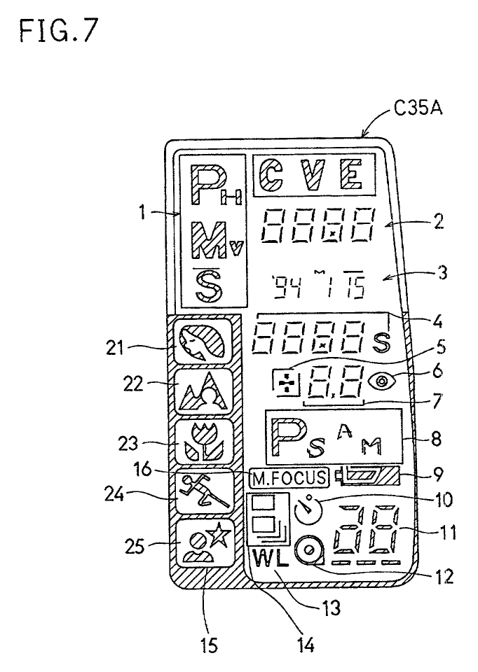

The image processor C24 comprises a processor unit for performing γ (gamma) correction, white balance (WB) correction and luminance/color-difference (Y/C) conversion, a memory unit for storing image data from the processor unit, an operational controller unit for processing image in response to a command from the camera microcomputer C01, a memory unit for storing image signals from the operational controller unit, and a superimposer unit for performing superimposing. The image signals processed by the image processor C24 are transmitted to an EVF (Electronic ViewFinder) unit C27, a recording/reproduction converter C25, and an external output port C32 which is also shown in FIG. 6. In FIG. 1, the part from a to a of the transmission path between the image processor C24 and the external output port C32 is not shown for reasons of space.

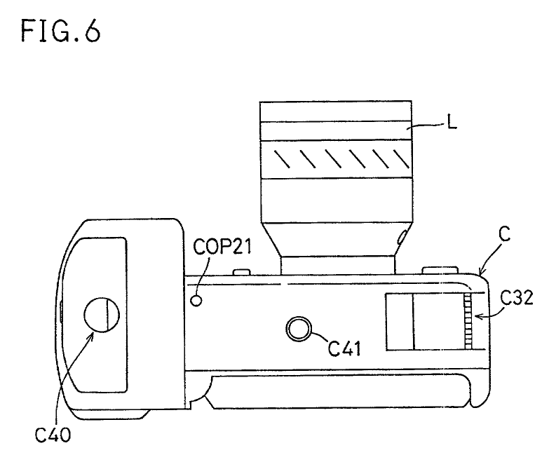

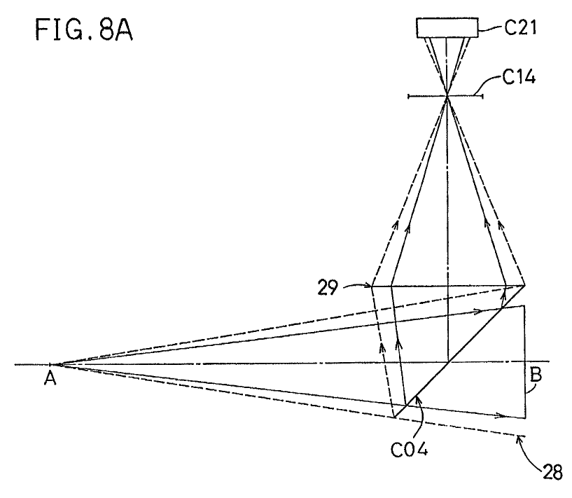

The EVF unit C27 for displaying images comprises a viewfinder unit including a liquid crystal finder, a cathode ray tube (CRT) or the like, and a converter unit for converting image signals from the image processor C24 into signals for driving the display unit. C35 represents an operation indication unit for displaying information on operation of the operation unit C0P. The operation indication unit includes a large-size liquid crystal display panel C35A as shown in FIGS. 3 and 7, and a lamp C35B as shown in FIG. 5.

The recording/reproduction converter C25 encodes image signals from the image processor C24, sound signals from a sound processor C31, and other signals and information from the camera microcomputer C01 into signals adapted for a recording format, and transmits the encoded signals to a head C26. C28 represents a recording medium. As the recording medium, a magnetic tape, a magneto-optical disk, a solid-state memory (RAM) or other may be used. In this embodiment, a videocassette tape loaded with a magnetic tape is used as a representative of the recording medium.

C36 represents a recording medium driver for driving the recording medium C28. The signals transmitted to the head C26 are recorded onto the recording medium C28 driven by the recording medium driver C36. Likewise, the data recorded on the recording medium C28 are read out by the head C26, and, through decoding by the recording/reproduction converter C25, reproduced as image signals, sound signals, other signals and information, which are then transmitted to the image processor C24 and to the sound processor C31.

C37 represents a silver salt shooting information recording section for recording various information onto an information recording area on a film, and it includes a converter unit for converting the information from the camera microcomputer C01 into a format for recording, and a head for performing recording. In some cases, the silver salt information recording section C37 is so constructed that it can perform reproduction as well as recording.

Sound is picked up by a stereophonic microphone C34 provided in a suitable position on the front surface of the camera body C as shown in FIG. 5, and is processed by the sound processor C31. The sound signals processed by the sound processor C31 are transmitted to the recording/reproduction converter C25, to a speaker C33, and to an output port C32. In FIG. 1, the part from b to b of the transmission path between the sound processor C31 and the microphone C34 is not shown for reasons of space. C29 represents a battery provided in the camera body C to supply power to the camera body C and to the main lens L.

C03 represents a camera-shake detector which detects a camera-shake of the entire camera system with the main lens L attached to the camera body C, and transmits the detection signal to the camera microcomputer C01. The camera-shake compensation in the video signal shooting sections is performed by controlling the readout area of the CCD image sensor C21.

Next, the operation unit C0P will be described below with reference to the external views of the present embodiment shown in FIGS. 3 to 6. C0P09 represents an operation mode selecting switch which also serves as a main switch. By operating the switch C0P09, it is possible to select one of six operation modes OFF, P_{M}, P_{H}, M_{V}, V, SV and E in total.

More specifically, the selecting switch C0P09 is switched to the OFF position to turn the entire apparatus off, to the P_{M} position to activate a simultaneous shooting mode in which video movie shooting and silver salt shooting can be simultaneously performed, to the P_{H} position to activate a silver salt shooting mode in which silver salt shooting can be performed, to the M, position to activate a video shooting mode in which video movie shooting can be performed, to the V position to activate a video reproduction mode in which a recorded video can be reproduced, to the SV position to activate a still video shooting mode in which still video image shooting can be performed, and to the E position to activate an edit mode in which information recorded on a shooting information recording portion of the silver salt film C08 can be edited.

C0P01 represents a release button used in silver salt shooting. C0P02 represents a switching dial for varying aperture values (AV) and time values (TV) and for switching modes in silver salt shooting and video movie shooting. By turning the switching dial C0P02 while holding down a subsequently-described mode button C0P07, a shooting scene is selected. By turning the switching dial C0P02 while holding down a subsequently-described program button C0P12, a mode is selected from among an A (aperture priority) mode, an S (shutter speed priority) mode and an M (manual) mode.

C0P03 represents a deck open button for ejecting a videocassette tape C28 serving as a recording medium. Operation of the button C0P03 opens a grip portion to allow loading and unloading of the videocassette tape C28. C0P04 represents an operation button which functions as a fade-out button for starting fade-out in video shooting mode (M_{V}) and simultaneous shooting mode (P_{M}) and which functions as a trigger button for triggering a preview of a still image in silver salt shooting mode (P_{H}) and still video shooting mode (SV).

C0P05 represents a lens exchange button for detaching the main lens L from the camera body C. C0P06 represents a red-eye reduction button for activating a red-eye reduction function in flash shooting in silver salt shooting mode (P_{H}) and still video shooting mode (SV). C0P07 represents a mode button which is operated together with the mode switching dial C0P02 to select a shooting scene such as a portrait scene or a sports scene in simultaneous shooting mode (P_{M}), silver salt shooting mode (P_{H}), video shooting mode (M_{V}) and still video shooting mode (S_{V}).

C0P08 represents a film cartridge exchange button for loading and unloading a film cartridge. C0P10 represents a frame aspect ratio changing switch for silver salt shooting. C0P11 represents a video movie frame size changing switch. C0P12 represents a program button which, when operated alone, switches the shooting mode to a program mode. By operating the program button C0P12 together with the mode switching dial C0P02, a mode can be selected from among the A (aperture priority) mode, the S (shutter priority) mode and the M (manual) mode in simultaneous shooting mode (P_{M}), silver salt shooting mode (P_{H}), video shooting mode (M_{P}), and still video shooting mode (SV).

C0P13 represents a zooming button which varies the focal length of the main lens L as the zooming ring of the main lens L does. C0P14 represents a recording ON/OFF button which controls starting and stopping of recording onto the recording medium C28 in simultaneous shooting mode (P_{M}) and video shooting mode (M_{V}). In silver salt shooting mode (P_{M}) and still video shooting mode (SV), by pressing the operation button C0P04 while holding down the button C0P14, an image shot with the aperture diaphragm open is displayed in the EVF unit C27. By operating the switching dial C0P02 while holding down the button C0P14, the value of AV is varied.

C0P15 represents a camera-shake compensation ON/OFF button for activating and deactivating camera-shake compensation in simultaneous shooting mode (P_{M}) and video shooting mode (M_{V}). In silver salt shooting mode (P_{H}) and still video shooting mode (SV), by operating the mode switching dial C0P02 while holding down the button C0P15, exposure compensation is performed.

C0P16 represents a first liquid crystal unit pop-up button. By operating the button C0P16, a liquid crystal unit forming the EVF unit C27 is popped up, and the grip portion is unlocked to allow the EVF unit C27 together with the grip portion to rotate around the camera body C. Thus, it is possible to shoot not only at eye level but also at waist level.

C0P17 represents a forced flashing button for forcibly firing a flash in silver salt shooting mode (P_{H}) and still video shooting mode (SV). C0P18 represents a message display ON/OFF button for turning on and off messages displayed in the EVF unit C27. C0P19 represents a button for controlling sound volume and picture qualities (brightness, hue, and others) of images displayed in the EVF unit C27 in V mode.

C0P20 represents a second liquid crystal pop-up button. By operating the button C0P20, the liquid crystal unit forming the EVF unit C27 is unfolded longitudinally. Thus, it is possible, for example, to shoot at waist level holding the apparatus vertically in silver salt shooting mode (P_{H}) and still video shooting mode (SV).

C0P21 represents an automatic rewinding button for starting rewinding of a film even at a midpoint in a roll. C0P22 represents a single-shot/continuous/self-timer button for switching among single-shot, continuous and self-timer shooting in silver salt shooting mode (P_{H}) and still video shooting mode (SV). In FIGS. 5 and 6, C40 represents a lid of a battery cavity and C41 represents a tripod hole.

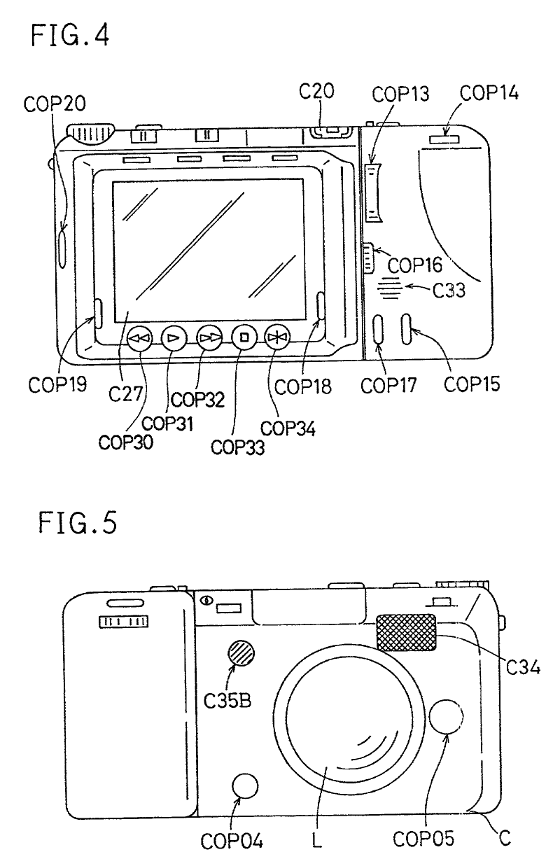

In FIG. 4, C0P30 to C0P34 represent a group of buttons for controlling video. C0P30 represents a rewind button, C0P31 represents a playback button, C0P32 represents a fast-forward button, C0P33 represents a stop button, and C0P34 represents a pause button.

In FIG. 3, C0P 35 represents a counter ON/OFF button for turning on and off a counter that is displayed in the EVF unit C27 in simultaneous shooting (P_{M}) mode and video shooting mode (M_{V}). C0P36 represents an automatic button for switching between automatic and manual operation of white balance (WB) adjustment in simultaneous shooting mode (P_{M}) and video shooting mode (M_{V}). C0P37 represents a menu button for turning on the display of a menu in the EVF unit C27. C0P38 represents a standby button for driving a recording medium C28 up to its last recording area.

FIG. 7 shows an example of the large-size liquid crystal display panel C35A of the operation indication unit C35. As shown in the figure, the large-size liquid crystal display panel C35A includes a camera operation mode indicator 1, a tape run counter 2, a date indicator 3, a shutter speed indicator 4, an exposure compensation indicator 5, a red-eye reduction indicator 6, an aperture value/exposure compensation value indicator 7, a mode indicator 8, a battery level indicator 9, a self-timer mark 10, a film counter 11, a film cartridge mark 12, a wireless flash indicator 13, a winding mode indicator 14, a shooting scene selection indicator 15, a manual focus indicator 16, and others.

The shooting scene selection indicator 15 is equipped with switching buttons for selecting a condition for the following shooting scenes: portrait 21, landscape 22, close-up 23, sports 24, and night portrait/night 25. The lamp C35B shown in FIG. 5 is lit in self-timer shooting and in red-eye reduction shooting.

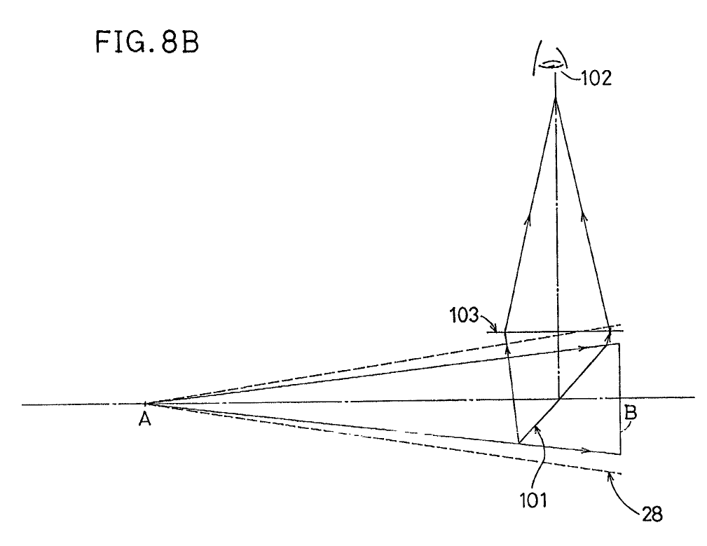

Next, the structure of the pellicle mirror C04 and the relay optical system for the video signal shooting sections will be described below with reference to FIGS. 8A and 8B. FIG. 8B shows how a light beam is directed to a viewfinder 102 by a pellicle mirror 101 in a conventional image shooting apparatus. Point A represents the center of the pupil of the main lens L. Plane B represents a film exposure surface. If the film exposure surface B is supposed to have an area of 100, the light beam reflected by the pellicle mirror 101 toward a focal plane 103, which directs the light beam to the viewfinder 102, has an area of 90 to 100 at the focal plane.

FIG. 8A shows the structure of the pellicle mirror C04 and the relay optical system including the relay lens C14 of this embodiment for directing the subject light incident through the main lens L to the CCD image sensor C21. The image circle 28 of the main lens L is larger than the light beam incident on the film exposure surface B. Accordingly, the light beam exiting from the main lens L has an area of 100 or more in this embodiment.

In order to utilize such an extra amount of light, the present invention is provided with a larger pellicle mirror C04, a larger condenser lens on the primary image plane 29, and a relay optical system of a larger capacity. As a result, the light beam reaching the CCD image sensor C21 has an area larger than 100. The extra amount of light is used, as described later, for creating an area for electronic camera-shake compensation and for realizing a wide viewfinder.

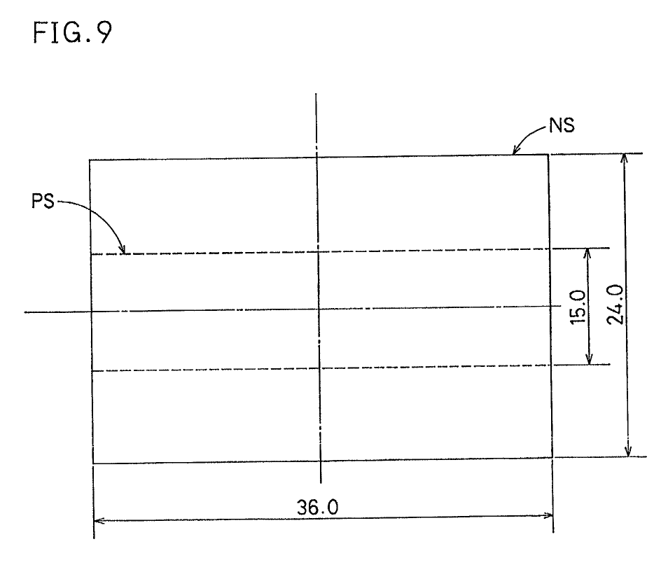

FIG. 9 shows the exposure area of a 135 film. The exposure area of a 135 film is 36.0×24.0 mm in normal shooting NS, and 36.0×15.0 mm in panoramic shooting PS. A brownie film such as 220 film has, as is well known, a plurality of formats such as 6×4.5, 6×6, 6×7 and 6×9, though not shown in the figure.

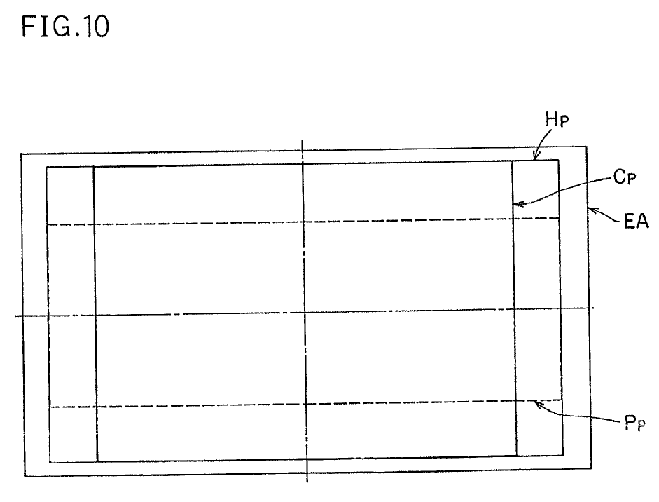

FIG. 10 shows the exposure area EA and the print sizes (C_{P}, H_{P} and P_{P}) on a film for a silver salt film system having three formats 16:9, 3:2 and 3:1 disclosed in Japanese Laid-open Patent Application No. H7-84309 (hereinafter, referred to as the film system of another standard). According to the silver salt film system shown in the figure, the print size H_{P} is slightly smaller than the exposure area EA. In comparison with the print size H_{P}, the print size C_{P} is narrower, that is, horizontally smaller in the figure, and the print size P_{P} is shorter, that is, vertically smaller in the figure.

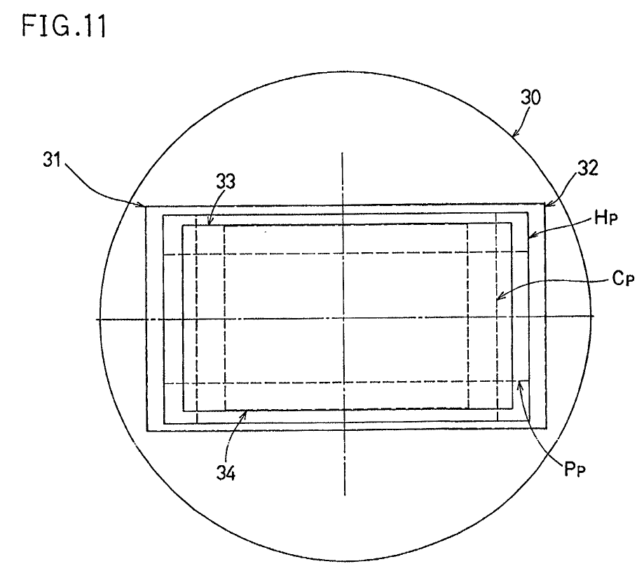

FIGS. 11 to 13 show examples of arranging the CCD image sensor C21, the movie format frame and the silver salt film format frame according to the film system of another standard. It is to be noted especially that an electronic camera-shake compensation system is adopted here. The electronic camera-shake compensation system requires an area approximately 1.5 times larger than the screen size. This corresponds to a linear ratio of approximately 1.2 times.

FIG. 11 shows an example in which the CCD image sensor C21 is of the wide-size (16:9) type and in which the film exposure area 32 and the image area 31 of the CCD are substantially the same. The movie frame 33 of H size is slightly smaller than the print area (H_{P}) of the same standard, since it is necessary to secure a camera-shake compensation area. The print area (H_{P}) is a 90% reduction of the film exposure area 32. Reference numeral 34 represents the movie frame of normal size. Reference numeral 30 represents an image circle of the lens L.

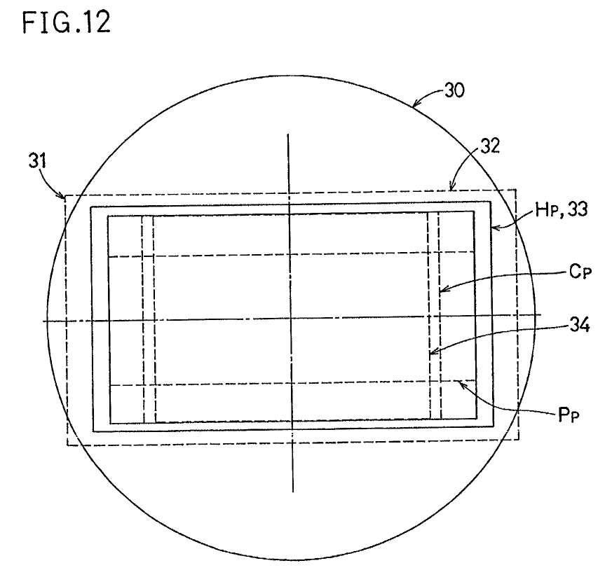

FIG. 12 shows an example in which the CCD image sensor C21 is of the wide-size type and in which a sufficient camera-shake compensation area is secured relative to the film exposure area 32. The size of the movie frame 33 is the same as the size of the silver salt film frame of the same standard. Accordingly, the frame size is constant irrespective of whether the camera-shake compensation switch (camera-shake compensation ON/OFF button C0P15) is set to on or off.

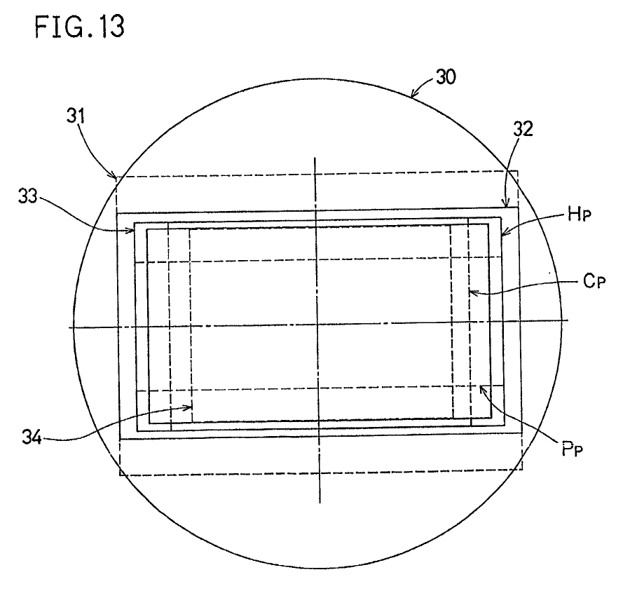

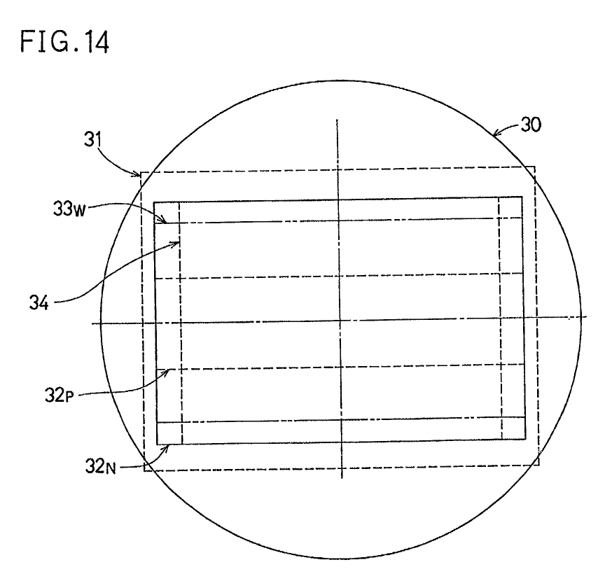

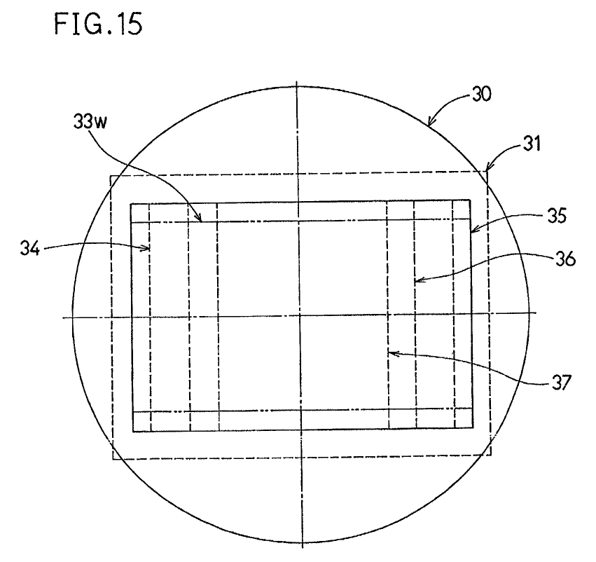

FIG. 13 shows an example in which the CCD image sensor C21 is of the normal-size (4:3) type and in which the upper and lower areas of the CCD image sensor C21 are used only for camera-shake compensation. FIG. 14 shows an example of arranging the CCD image sensor C21, the movie format frame and the silver salt format frame for a 135 film. Reference numerals 32_{P} and ³²N represent the film exposure areas of the panorama and normal formats, respectively. FIG. 15 shows the same for a brownie film. Reference numerals 35, 36 and 37 represent the frames of formats 6×9, 6×6, 6×4.5, respectively.

Next, a description will be given below as to screens displayed in the EVF unit with the arrangement of the CCD image sensor, the movie format frame and the silver salt film format frame as shown in FIG. 12 according to the film system of another standard.

First, to activate silver salt shooting mode, the operation mode selecting switch C0P09 is set to the silver salt shooting mode (P_{H}) position, whereby operation buttons are set to be ready for the silver salt shooting mode (P_{H}) by the camera microcomputer C01, and the video signal shooting sections are activated. As a result, the subject image having passed through the main lens L forms an image on the CCD image sensor C21 through the relay lens C14, and the thus formed image, after being processed by the image forming processor C22 and by the image processor C24, is displayed on the EVF unit C27.

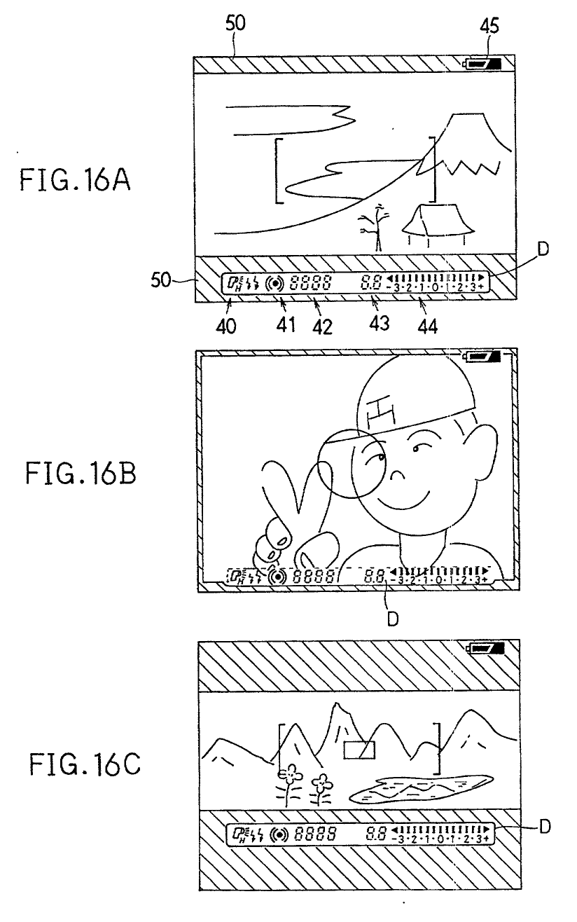

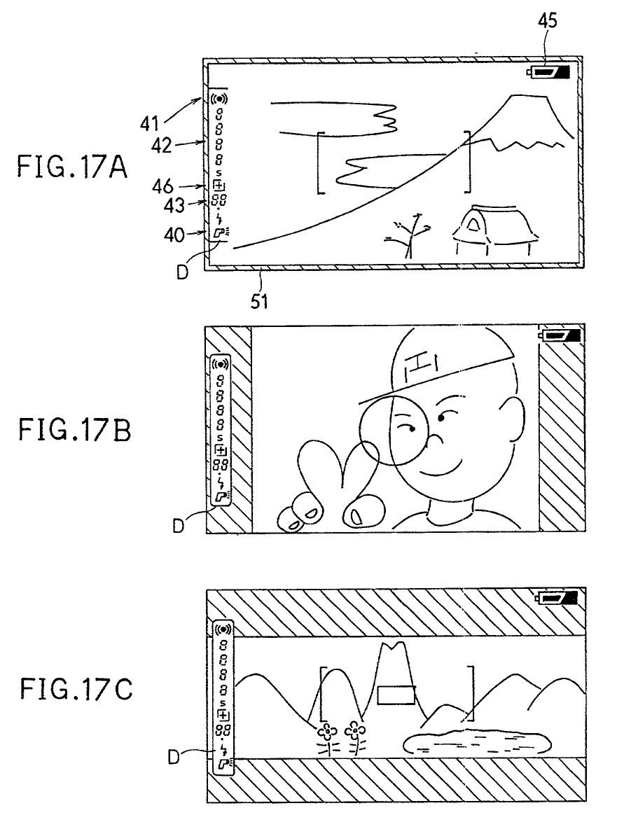

Details of the screens displayed in this mode are shown in FIGS. 16A to 18B. In FIGS. 16A, 16B and 16C, the EVF unit C27 has the aspect ratio of 4:3 corresponding to a typical television format. In FIGS. 17A, 17B and 17C, the EVF unit C27 has the aspect ratio of 16:9 corresponding to a wide-size (high-vision size) television format. Here, a frame size can be changed to another frame size by operating the switch C0P10. Specifically, when the switch C0P10 is set in the H position, the image formed in the print area (H) shown in FIG. 12 is extracted and displayed in the EVF unit C27.

In the EVF unit of the aspect ratio of 4:3, since there remain portions which are not used for display as shown in FIG. 16A, shooting data D is displayed in those remaining portions. As shown in the figure, the shooting data D includes a flash shooting indication 40, an in-focus mark 41, a shutter speed indication 42, an aperture value indication 43, an exposure correcting value indication 44. The portions not used for display are displayed in a color (blue, for example) representing silver salt shooting in silver salt shooting, so that the user can recognize in what mode shooting is performed. In these figures, hatched portions 50 represent the portions displayed with the color representing silver salt shooting. Reference numeral 45 represents a battery indication.

In the wide-size EVF and the like, since a displayed image uses almost the whole display area of the EVF unit C27 as shown in FIG. 17A, the shooting data D are superimposed over the image. Reference numeral 46 represents an exposure correcting mark. The frame edges 51 are displayed in the color representing silver salt shooting.

When the switch C0P10 is set in the C position, the image formed in the print area C shown in FIG. 12 is extracted and displayed on the EVF unit C27. In the normal EVF, since a displayed image uses almost the whole display area of the EVF unit C27 as shown in FIG. 16B, shooting data D are superimposed over the image frame. The frame edges are displayed in the color representing silver salt shooting.

In the wide-size EVF and the like, since there remain portions which are not used for display as shown in FIG. 17B, shooting data D are displayed in those remaining portions. The portions not used for display are displayed in the color representing silver salt shooting.

When the switch C0P10 is set in the P position, the image formed in the print area (P) shown in FIG. 12 is extracted and displayed on the EVF. In the normal EVF and in the wide-size EVF and the like, since there remain portions which are not used for display as shown as shown in FIG. 16C and FIG. 17C, shooting data D are displayed in those remaining portions. The portions not used for display are displayed in the color representing silver salt shooting. In silver salt shooting, the electronic camera-shake compensation does not function.

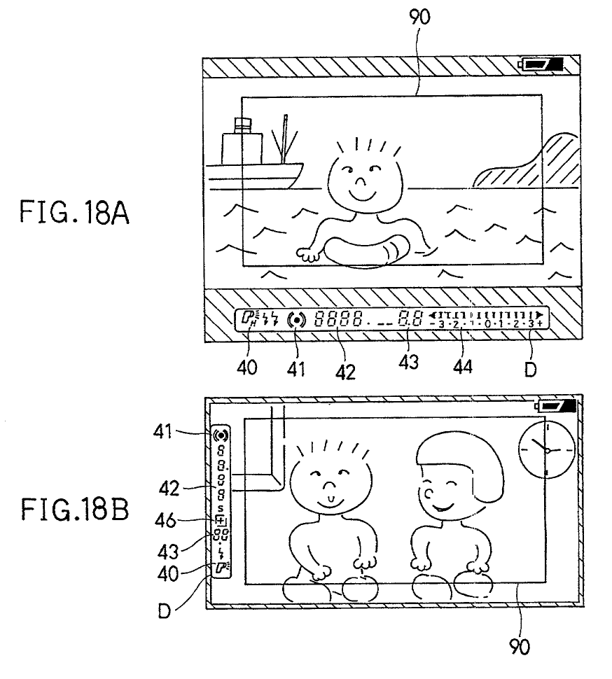

FIGS. 18A and 18B shows a screen displayed when the wide viewfinder display is used. When the wide viewfinder switch (not shown in the figure) is set to ON under the condition that the switch C0P10 is in the H position, the whole image formed on the CCD image area shown in FIG. 12 is displayed in the EVF unit C27. Moreover, a picture frame mark 90 representing the print area (H) is also displayed as shown in FIGS. 18A and 18B. Next, to activate video shooting mode, the operation mode selecting switch C0P09 is set to the video shooting mode (P_{V}) position, whereby operation buttons are set to be ready for the video shooting mode (P_{V}) by the camera microcomputer C0, and the video signal shooting sections are activated. As a result, the subject image having passed through the main lens L forms an image on the CCD image sensor C21 through the relay lens C14, and the thus formed image, after being processed by the image forming processor C22 and by the image processor C24, is displayed on the EVF unit C27.

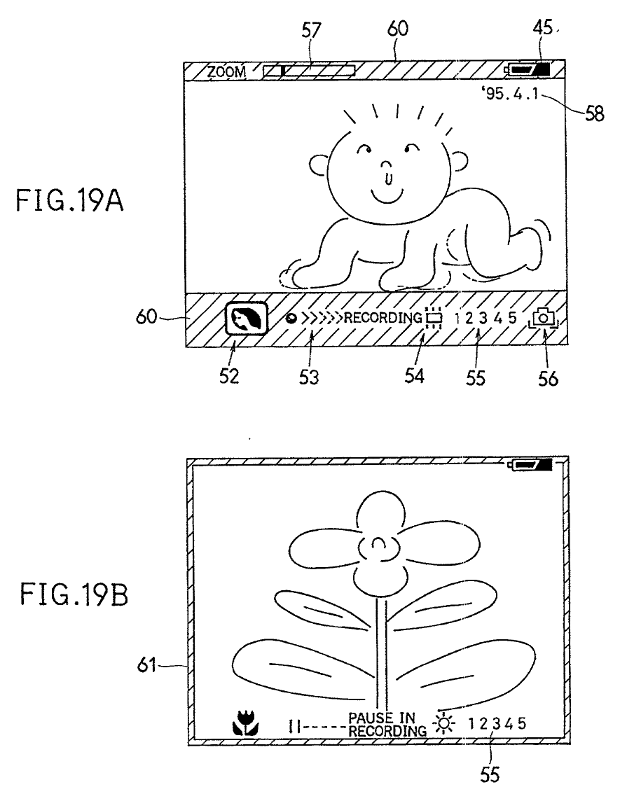

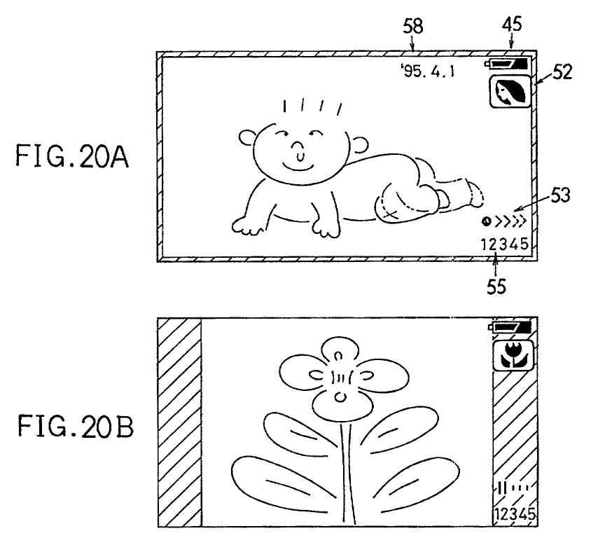

Details of the displayed screens are shown in FIGS. 19A, 19B, 20A and 20B. In FIGS. 19A and 19B, the EVF unit C27 has the aspect ratio of 4:3 corresponding to the typical television format. In FIGS. 20A and 20B, the EVF unit C27 has the aspect ratio of 16:9 corresponding to the wide-size (high-vision size) television format.

In this case, when the video movie frame size changing switch C0P11 is set in the H position (wide-size), the image formed within the frame size of the movie H size shown in FIG. 12, that is, the image formed in the print area (H) is extracted and displayed in the EVF unit C27. In the normal EVF, since there remain portions which are not used for display as shown in FIG. 19A, shooting data D are displayed in those remaining portions. The shooting data D include a shooting mode indication 52, a movie-recording-in-progress indication 53, a white balance mark 54, a tape counter 55, a camera-shake compensation indication 56, and a zoom position indication 57. The portions 60 not used for display are displayed in a color (e.g. orange) representing video shooting so that the user can recognize in what mode shooting is performed. In FIG. 19A, reference numeral 58 represents the date.

In the wide-size EVF, since a displayed image uses almost the whole display area of the EVF unit C27 as shown in FIG. 20A, shooting data D are superimposed over the image frame. The frame edges are displayed with the color representing video shooting.

When the switch C0P11 is set in the N position (normal-size), the image formed within the frame size of the movie N size shown in FIG. 12 is extracted and displayed in the EVF unit C27. In the normal EVF, since a displayed image uses almost the whole display area of the EVF unit C27 as shown in FIG. 19B, shooting data D are superimposed over the image frame. The frame edges 61 are displayed in the color representing video shooting.

In the wide-size EVF, since there remain portions which are not used for display as shown in FIG. 20B, shooting data D are displayed in those remaining portions. The portions not used for display are displayed in the color representing video shooting.

In video shooting mode, when the camera-shake compensation switch, that is, the camera-shake compensation control ON/OFF button C0P15 is operated, a camera shake is detected based on the output from the camera-shake detector in order to compensate for the camera-shake by changing the position of the frame within which the image on the CCD image sensor C21 is extracted.

Lastly, to activate simultaneous shooting mode, the operation mode selecting switch C0P09 is set to the simultaneous shooting mode (P_{M}) position, whereby operation buttons are set to be ready for the simultaneous shooting mode (P_{M}) by the camera microcomputer C01, and the video signal shooting sections are activated. As a result, the subject image having passed through the main lens L forms an image on the CCD image sensor C21 through the relay lens C14, and the thus formed image, after being processed by the image forming processor C22 and by the image processor C24, is displayed on the EVF unit C27.

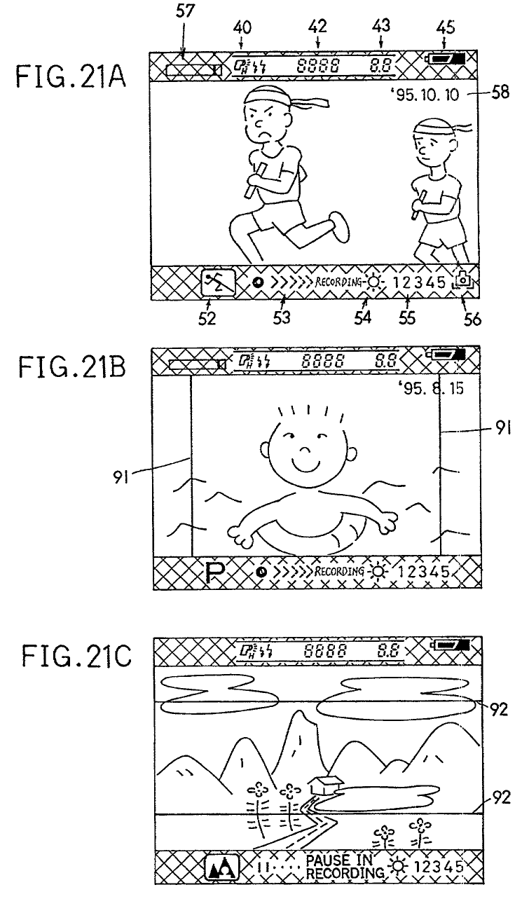

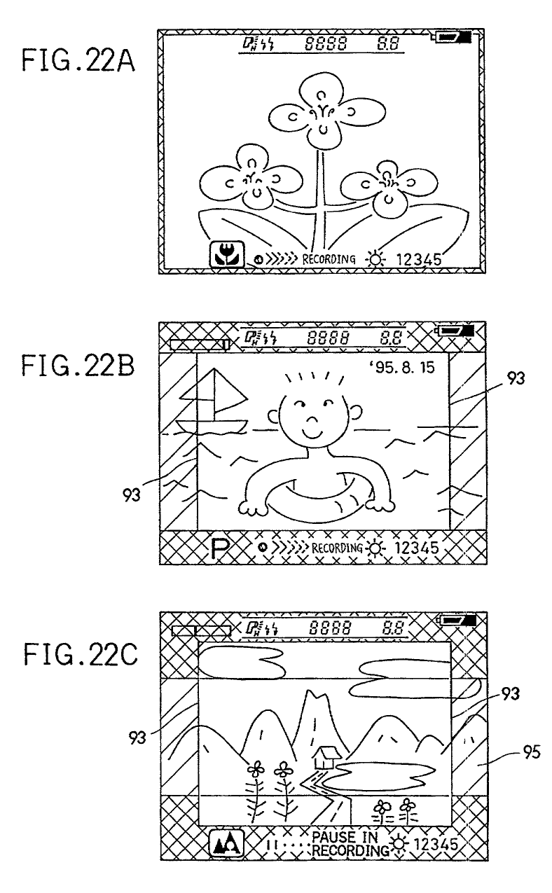

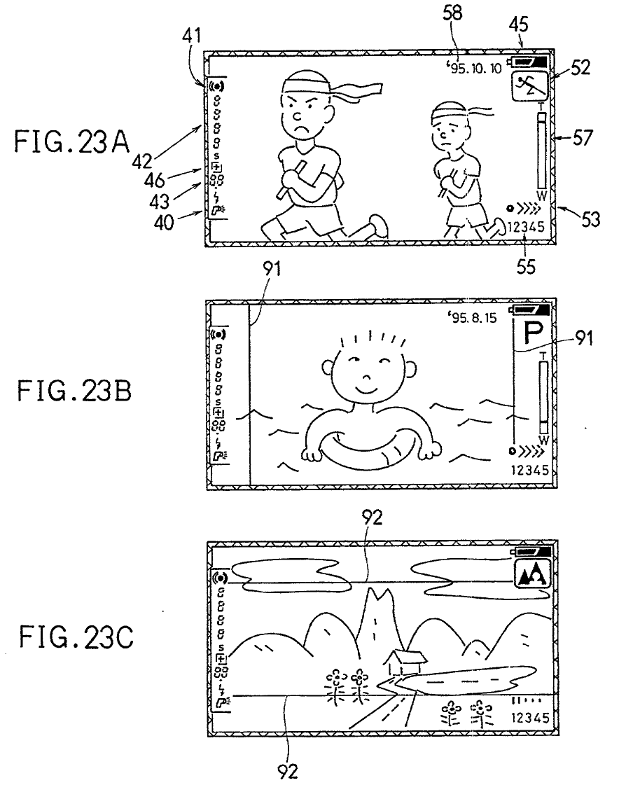

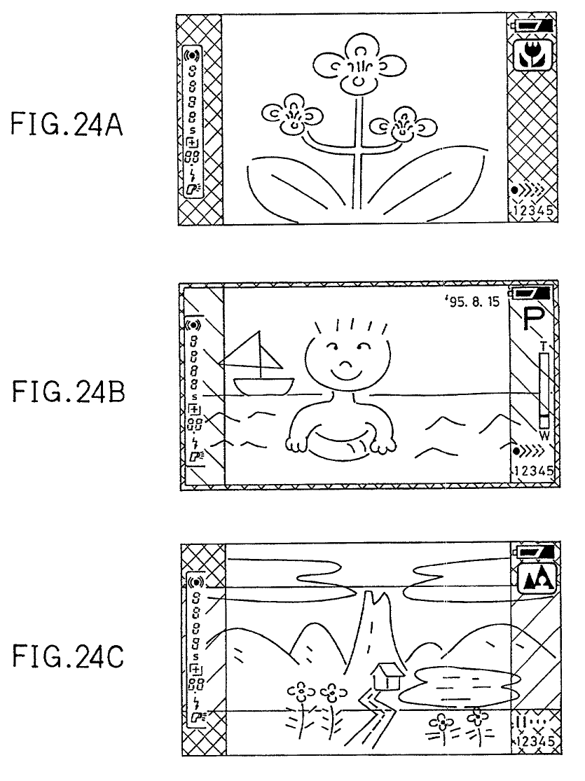

Details of the displayed screens are shown in FIGS. 21A to 26. In FIGS. 21A to 22C, the EVF unit C27 has the aspect ratio of 4:3 corresponding to a typical normal television format. In FIGS. 23A to 24C, the EVF unit C27 has the aspect ratio of 16:9 corresponding to the wide-size (high-vision size) television format.

In this case, when the video movie frame size changing switch C0P11 is set in the H position (wide-size) and the switch C0P10 is set in the H position, the image formed within the frame size of the movie H size shown in FIG. 12, that is, the image formed in the print area (H) is extracted and displayed in the EVF unit C27. In the normal EVF, since there remain portions which are not used for display as shown in FIG. 21A, shooting data D are displayed in those remaining portions. The portions not used for display are displayed in a color (e.g. green) representing simultaneous shooting so that the user can recognize in what mode shooting is performed.

In the wide-size EVF, since a displayed image uses almost the whole display area of the EVF unit C27 as shown in FIG. 23A, shooting data D are superimposed over the image frame. The frame edges are displayed in the color representing video shooting.

When the video movie image changing switch C0P11 is set in the H position (wide-size) and the switch C0P10 is set in the C position, the image formed within the frame size of the movie H size shown in FIG. 12 is extracted and displayed in the EVF unit C27. In the normal EVF, since the silver salt shooting frame is situated inside the video shooting frame as shown in FIG. 21B, the edges 91 of the silver salt shooting frame are displayed in the video shooting frame as shown in FIG. 21B. The frame edges 91 are displayed in blue, which represents silver salt shooting. In this case, the above description of FIG. 21B is also applicable to the wide-size EVF shown in FIG. 23B.

When the video movie image changing switch C0P11 is set in the H position (wide-size) and the switch C0P10 is set in the P position, the image formed within the frame size of the movie H size shown in FIG. 12 is extracted and displayed in the EVF unit C27. In the normal EVF, since the silver salt shooting frame is situated inside the video shooting frame as shown in FIG. 21C, the edges 92 of the silver salt shooting frame are displayed in the video shooting frame as shown in FIG. 23C. The frame edges 92 are displayed in blue, which represents silver salt shooting. In this case, the above description is also applicable to the wide-size EVF shown in FIG. 23C.

When the video movie image changing switch C0P11 is set in the N (normal-size) position and the switch C0P10 is set in the C position, the image formed within the frame size of the movie N size shown in FIG. 12 is extracted and displayed in the EVF unit C27. In the normal EVF, since a displayed image uses almost the whole display area of the EVF unit C27 as shown in FIG. 22A, shooting data D are superimposed over the image frame. The frame edges are displayed in the color representing simultaneous shooting.

In the wide-size EVF, since there remain portions which are not used for display as shown in FIG. 24A, shooting data D are displayed in those remaining portions. The portions not used for display are displayed in the color representing simultaneous shooting so that the user can recognize in what mode shooting is performed.

When the video movie image changing switch C0P11 is set in the N position and the switch C0P10 is set in the H position, the image formed within the frame size of the movie H size shown in FIG. 12 is extracted and displayed in the EVF unit C27. In the normal EVF, since the video shooting frame is situated inside the silver salt shooting frame as shown in FIG. 22B, the edges 93 of the video shooting frame are displayed in the silver salt shooting frame.

Since it is video that is normally shot, the image area for silver salt shooting is displayed with reduced brightness or in monochrome to prevent the screen from becoming ambiguous. The frame edges are displayed in orange, which represents video shooting. Here, it is also possible to make the silver salt shooting frame clear by changing the silver salt shooting frame area to the normal frame (as shown in FIG. 21B, but with the date indication displayed inside) with a halfway press of the release button C0P01. The same description is applicable to the wide-size EVF shown in FIG. 24B.

When the video movie image changing switch C0P11 is set in the N position and the switch C0P10 is set in the P position, the image formed within the frame size of the movie N size shown in FIG. 12 and the image formed in the print area (P) are extracted and displayed in the EVF unit C27. In the normal EVF, since the video shooting frame is situated inside the silver salt shooting frame as shown in FIG. 22C, the edges 93 of the video shooting frame are displayed in the silver salt shooting frame 95.

Since it is video that is shot in the normal procedure, the image area for silver salt shooting is displayed with reduced brightness or in monochrome to prevent the screen from becoming ambiguous. The frame edges are displayed in orange, which represents video shooting. Here, it is also possible to make the silver salt shooting frame clear by changing the silver salt shooting frame area to the normal frame with a halfway press of the release button C0P01, and by making the image area exclusively for video shooting be displayed with reduced brightness or in monochrome. The same description is applicable to the wide-size EVF shown in FIG. 24C.

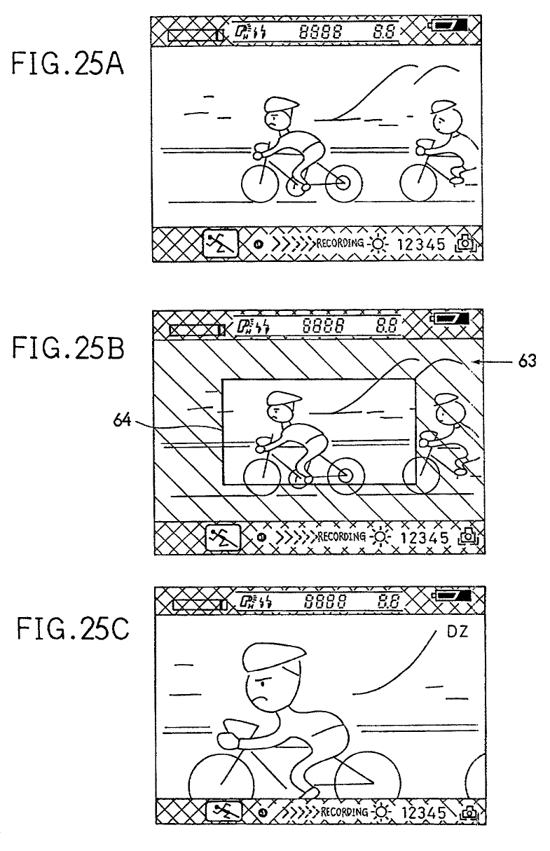

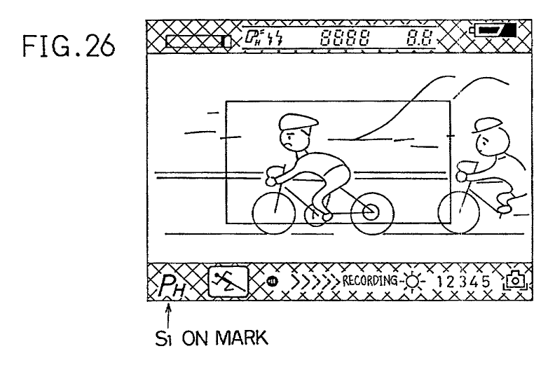

FIGS. 25A to 26 show examples of display in simultaneous shooting with electronic zooming. Before electronic zooming is started, a screen as shown in FIG. 25A is displayed. Here, electronic zooming means a method of achieving substantial zooming effects by varying the view angle of a recorded image through extraction of part of the image signal outputted from the CCD image sensor C21. When electronic zooming is started, a screen as shown in FIG. 25B appears, on the one hand. More specifically, since only the video shooting frame is in the normal state and it is video that is shot in the normal procedure, the image area 63 for silver salt shooting is displayed with reduced brightness or in monochrome to prevent the screen from becoming ambiguous. The frame edges are displayed in orange, which represents video shooting.

On the other hand, a display as shown in FIG. 25C is also available. More specifically, only the video shooting frame is displayed in an enlarged size, and an indication DZ is displayed for indicating that electronic zooming is in operation. Here, when the release button C0P01 is pressed halfway in, the frame for silver salt shooting is changed from the state shown in FIG. 25B to the normal state shown in FIG. 26. Or, when the release button C0P01 is pressed halfway, the enlargement of the video frame as shown in FIG. 25C is canceled, and the color of the edges 64 of the video shooting frame alone is changed to orange.

The above description deals with screens in the EVF unit C27 in the arrangement shown in FIG. 12. However, the same description applies to the arrangements shown in FIGS. 11 and 13. The same description also applies to a system using 135 films or Brownie films.

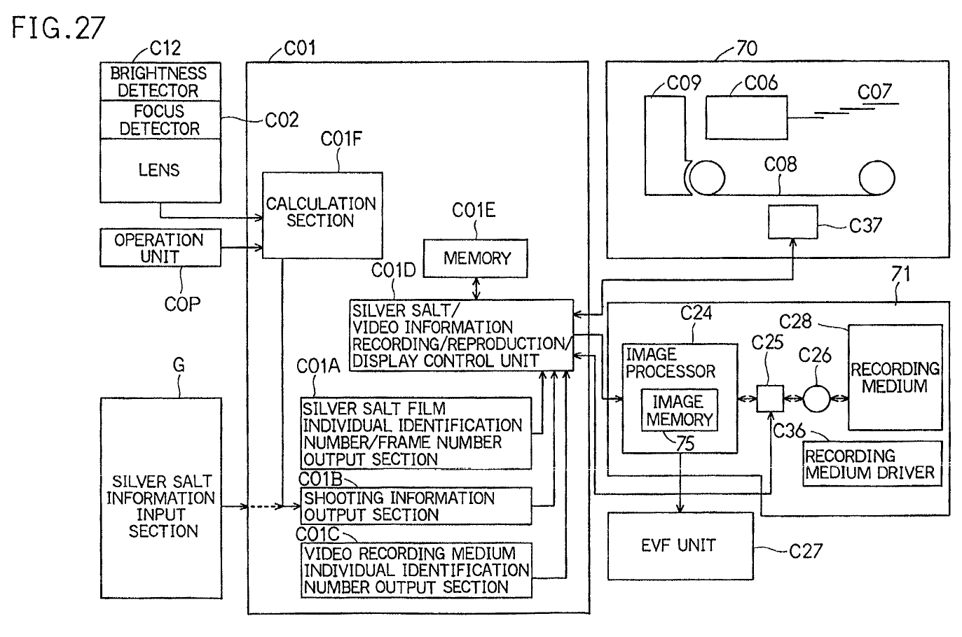

Hereinafter, a description will be given as to recording of various information on a silver salt film and on a recording medium, and as to displaying of the thus recorded information. FIG. 27 shows the construction of the relevant portions for these purposes. In the figure, G represents an silver salt information input section, with which the operator inputs information from the outside of the camera. By operating this input section G, information can be inputted to a shooting information output section C0B, which will be described later, of the camera microcomputer C01.

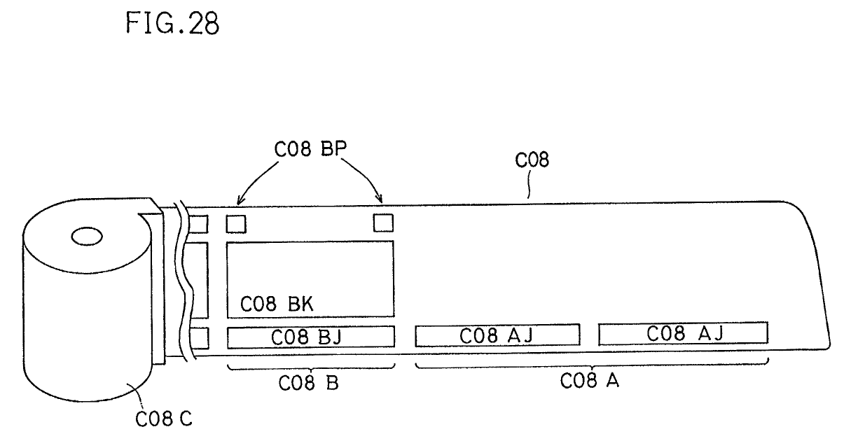

FIG. 28 shows a state of the silver salt film C08 pulled out from the film cartridge C08C. Part of the film C08 is coated with magnetic material so that information can be magnetically recorded thereupon. In this film C08, C08A represents a film leader portion including recording tracks C08AJ on which information relevant to the whole film is recorded. C08B is a portion corresponding to the first frame and comprises an image formation portion C08BK, perforations C08BP and a recording track C08BJ on which information relevant to each frame is magnetically recorded. The same pattern as this shooting-frame portion C08B is repeated up to the last end of the film as many times as the number of frames available for shooting.

When a film C08 is newly loaded into the video camera of the embodiment of the present invention, on detection of the loading, a silver salt film individual identification number/frame number output section C01A in the camera microcomputer C01 generates an individual identification number. The individual identification number is then transmitted to a silver-salt/video information recording/reproduction/display control unit C01D.

The control unit C01D transmits the individual identification number to the silver salt shooting information recording section C37 of the silver salt shooting sections in order to record the individual identification number on the recording track C08AJ of the film leader portion C08A. If an identification number is already recorded on the recording track C08AJ, the identification number is read out by the silver salt shooting information recording section C37 and is then transmitted to the control unit C01D. The control unit C01D transmits this identification number to the image processor C24 in the video signal recording/reproduction section so that the individual identification number of the loaded film C08 is displayed in the EVF unit C27.

When a recording medium C28 is newly loaded into the video signal recording/reproduction section 71 of the camera, on detection of the loading, a video recording medium individual identification number output section C01C in the camera micro-computer C01 generates an individual identification number. The individual identification number is then transmitted to the silver-salt/video information recording/reproduction/display control unit C01D. This control unit C01D transmits the individual identification number to the recording/reproduction converter C25 and the head C26 in the video signal recording/reproduction section 71 so that the individual identification number is recorded in the video information recording portion on the recording medium C28 and is displayed in the EVF unit C27 together with an indication that the medium is new.

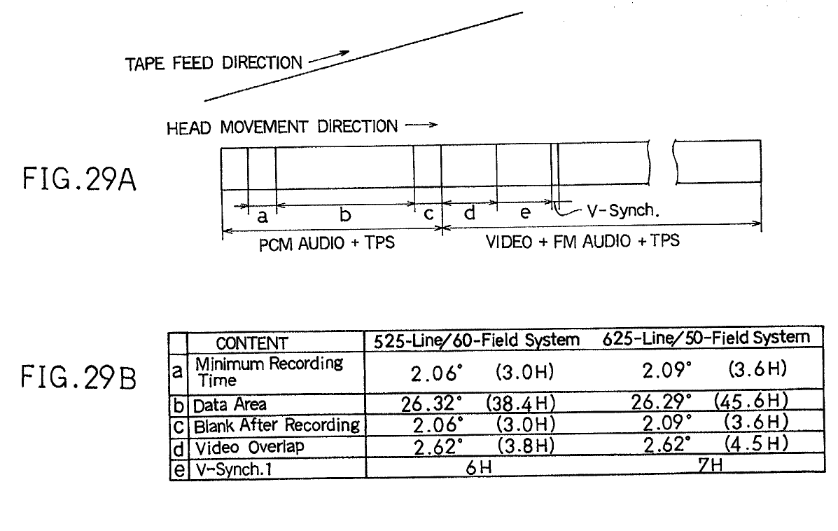

As an example, the data area (video information recording portion) of an 8 mm-format videocassette tape as a recording medium C28 is shown in FIGS. 29A and 29B. FIG. 29A shows various recording areas a to e on the magnetic tape. FIG. 29B explains the areas a to e. If an identification number is already recorded on the data area b, the recording/reproduction converter C25 and the head C26 reads out the identification number and transmits it to the control unit C01D. The control unit C01D transmits the identification number to the image processor C24 to display the individual identification number of the loaded recording medium C28 in the EVF unit C27 (the state in which the individual identification number is displayed is referred to as a set state).

Next, a description will be given below as to shooting in silver salt shooting mode (P_{H}) with the apparatus in a set state. When the operation mode selecting switch C0P09 is set to the P, position, the camera microcomputer C01 sets operation buttons ready for silver salt shooting mode (P_{H}). Simultaneously, the camera microcomputer C01 communicates with the lens microcomputer L06 and, when lens information is transmitted to the camera computer C01, the video shooting sections C21 to C23 shown in FIG. 1, the video signal recording/reproduction section 71 and the EVF unit C27 are activated.

When the user recognizes a subject in the EVF unit C27 and presses the release button C0P01 halfway in, the outputs of the brightness detector C12 and the focus detector C02 are transmitted to the camera microcomputer C01. A calculation section C01F in the camera microcomputer C01 processes those outputs with calculation to determine shooting conditions based on the lens information and the information on settings of the operation unit C0P.

When the release button C0P01 is further pressed, the aperture diaphragm L11 and the shutter C07 are controlled according to the determined shooting conditions, and silver salt shooting is performed. On completion of silver salt shooting, the film advancing controller C09 of the silver salt shooting section 70 advances the film C08 one frame forward. Here, the shooting conditions and shooting information of the shot that has just been taken are recorded on the magnetic track C08BJ corresponding to the frame of the shot on the film C08. Table 1 shows an example of shooting information.

In Table 1 below, the items of information listed under A are those which are most desirably recorded. The print aspect ratio is an item needed for specifying the aspect ratio when an image is printed and, as shown in FIG. 10 described above, there are three types H, C and P of print aspect ratios.

Moreover, in Table 1, the items of information listed under B are those which are recorded according to the settings made by the operation unit C0P. These items of information are gathered from a shooting information output section C01B and the video recording medium individual identification number output section C01C to the control unit C01D first, before they are supplied to the silver salt information recording section C37 in accordance with the settings made by the operation unit C0P to be recorded on the film C08.

TABLE 1

| A | B |
|---|---|
| Date and time | Light source information |
| Recording location of | (WB information) |
| information upon printing | Number of prints |
| procedure | Lens focal length |
| Print aspect ratio | Aperture value |
| Identification number of | Shutter speed |
| the corresponding recording | Exposure compensation |
| media | value |
| | Film ISO sensitivity |
| | Title |
| | TV-display aspect ratio |
| | Subject brightness |
| | Photometry method |

Simultaneously, the information is also recorded in a memory C01E in the camera microcomputer C01. The items to be recorded here may be the same as those recorded on the film C08, or different items may be selected. The memory C01E is required to have a capacity sufficient for storing information throughout a whole role of film, so that it can keep information at least until films are exchanged. The memory C01E comprises a semiconductor memory.

Simultaneously with shooting, in the video signal recording/reproduction section 71, an image signal obtained almost simultaneously with the shooting is stored in an image memory 75 in the image processor C24. The image memory 75 comprises a semiconductor memory. When the recording medium C28 becomes ready for recording, the image signal is read out from the image memory 75 to be recorded on the medium as a still image together with information outputted from the control unit C01D. The items of information thus recorded are shown in Table 2 below.

TABLE 2

| A | B |
|---|---|
| Date and time | Light source information |
| Recording location of | (WB information) |
| information upon printing | Number of prints |
| procedure | Lens focal length |
| Print aspect ratio | Aperture value |
| Identification number of | Shutter speed |
| the corresponding film | Exposure compensation |
| Frame number of the | value |
| corresponding film | Film ISO sensitivity |
| | Subject brightness |
| | Photometry method |
| | Title |
| | TV-display aspect ratio |

In Table 2 above, the items of information listed under A are those which are most desirably recorded. The items of information listed under B are those which are recorded according to the settings made by the operation unit C0P. These items of information are gathered from the shooting information output section C01B and the silver salt film individual identification number/frame number output section C01A to the control unit C01D first, before they are outputted to the recording/reproduction converter C25 in accordance with the settings made by the operation unit C0P to be recorded on the recording medium C28.

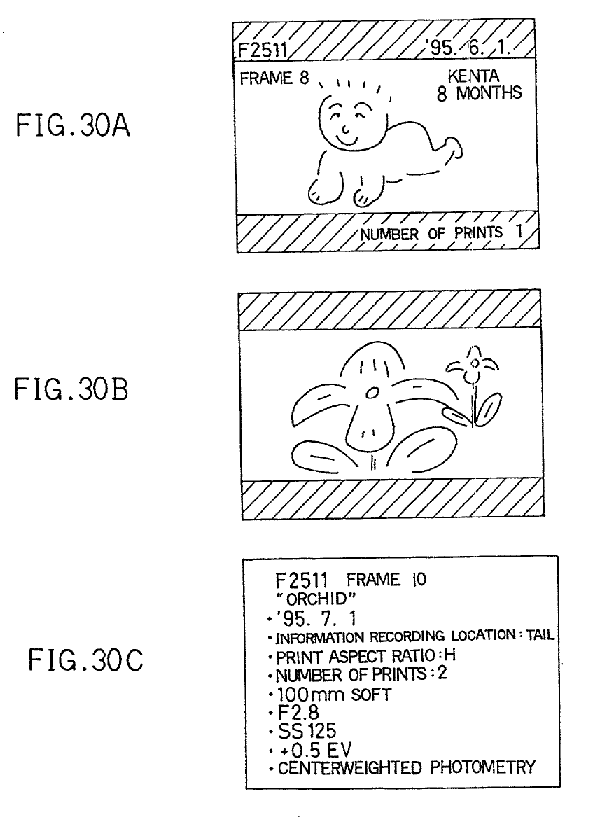

According to one method of recording the information onto the recording medium C28, the information is recorded in the data area b shown in FIGS. 29A and 29B. As another method of recording the information, FIGS. 30A to 30C show an example of recording and reproducing the information in the form of characters onto and from the video recording area or a video recording medium. According to this method, the information may be recorded in the form of characters on the screen as shown in FIG. 30A, or on the screen (FIG. 30C) immediately following the screen of a still image (FIG. 30B) as shown in FIGS. 30B and 30C. Further, it is also possible to simultaneously record the information both in the form of characters and in the data area.

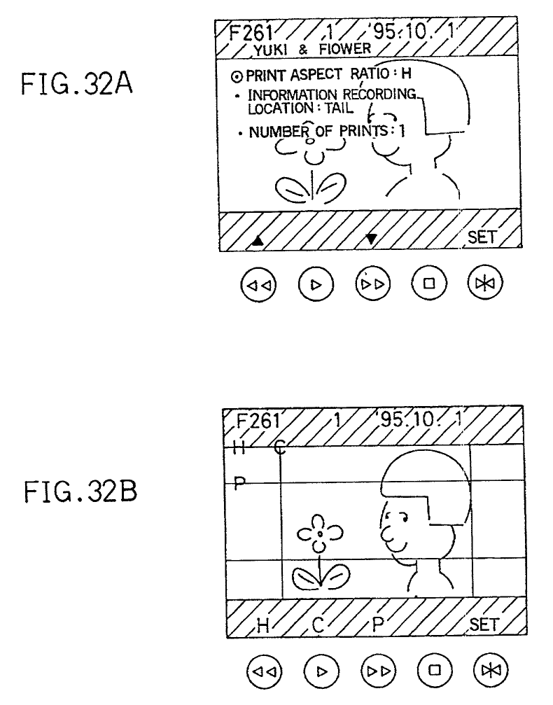

Here, a still image is so recorded that it can be adapted for a plurality of print aspect ratios in case the aspect ratio is changed in edit mode (E) described later. Moreover, on the EVF screen immediately after shooting, the information in the form of characters and the subject image are displayed in a mixed fashion on the same screen as shown in FIG. 32A, and it is possible to rewrite the shooting information as described later.

Next, a description will be given below as to shooting in simultaneous shooting mode (P_{M}) with the apparatus in a set state. When the operation mode selecting switch C0P09 is set to the PM position, the camera microcomputer C01 sets operation buttons ready for simultaneous shooting mode (P_{M}). Simultaneously, the camera microcomputer C01 communicates with the lens microcomputer L06, and lens information is transmitted to the camera microcomputer C01.

Thereafter, the focus detector C02 and the brightness detector C12 is activated to perform AE by an automatic aperture adjustment and AF (automatic focus adjustment) operations. Further, the shooting section 70, the video signal recording/reproduction section 71 and the EVF unit C27 are activated to display a subject image captured through the taking lens (the main lens L) in the EVF unit C27. When the user recognizes a subject in the EVF C27 and operates the recording ON/OFF button, recording of a movie is started.

In the movie-recording state, when the release button C0P01 is pressed halfway in, the outputs of the focus detector C02 and the brightness detector C12 are transmitted to the camera microcomputer C01. The calculation section C01F processes those outputs with calculation to determine shooting conditions based on the lens information and the information on settings of the operation unit C0P.

When the release button C0P01 is further pressed, the aperture diaphragm L11 and the shutter C07 are controlled according to the determined shooting conditions, and silver salt shooting is performed. On completion of silver salt shooting, the film advancing controller C09 of the silver salt shooting section 70 advances the film C08 one frame forward. Here, the shooting conditions and shooting information of the shot that has just been taken are recorded on the magnetic track C08BJ corresponding to the frame of the shot on the film C08. Meanwhile, recording of the movie is continued. Table 3 below shows the items of shooting information in this case.

TABLE 3

| A | B |
|---|---|
| Date and time | Light source information |
| Recording location of | (WB information) |
| information upon printing | Number of prints |
| procedure | Lens focal length |
| Print aspect ratio | Aperture value |
| Identification number of | Shutter speed |
| the corresponding recording | Exposure compensation |
| medium | value |
| | Film ISO sensitivity |
| | Subject brightness |
| | Photometry method |
| | Title |
| | TV-display aspect ratio |

In Table 3 above, the items of information listed under A are those which are most desirably recorded. The items of information listed under B are those which are recorded according to the settings made by the operation unit C0P. These items of information are gathered from the shooting information output section C01B and the video recording medium individual identification number output section C01C to the control unit C01D first, before they are outputted to the silver salt information recording section C37 according to the settings made by the operation unit C0P and are recorded on the film C08. Simultaneously, the information is also recorded in the memory C01E in the camera microcomputer C01. The items recorded here may be the same as those recorded on the film C08, or different items may be selected.

Simultaneously with shooting, in the video signal recording/reproduction section 71, an image signal obtained almost simultaneously with the shooting is recorded together with the information outputted from the control unit C01D. The items of the recorded information are shown in FIG. 4 below.

TABLE 4

| A | B |
|---|---|
| Date and time | Light source information |
| Recording location of | (WB information) |
| information upon printing | Number of prints |
| procedure | Lens focal length |
| Print aspect ratio | Aperture value |
| Identification number of | Shutter speed |
| the corresponding film | Exposure compensation |
| Frame number of the | value |
| corresponding film | Film ISO sensitivity |
| In process of movie | Subject brightness |
| shooting | Photometry method |
| | Title |
| | TV-display aspect ratio |

In Table 4 above, the items of information listed under A are those which are most desirably recorded. The items of information listed under B are those which are recorded according to the settings made by the operation unit C0P. These items of information are gathered from the shooting information output section C01B and the silver salt film individual identification number/frame number output section C01A to the control unit C01D first, before they are outputted to the recording/reproduction converter C25 according to the settings made by the operation unit C0P and are recorded on the recording medium C28. The items recorded here may be the same as those recorded on the film C08, or different items may be selected.

According to one method of recording the information onto the recording medium C28, the information is recorded on the data area b shown in FIGS. 29A and 29B. Alternatively, the information may be recorded on the video area in the form of characters on the screen as shown in FIG. 30A, or on the screen (FIG. 30C) immediately following the screen of a still image (FIG. 30B) as shown in FIGS. 30B and 30C. Further, it is also possible to simultaneously record the information both in the form of characters and in the data area. It is to be noted, however, that screens containing only information in the form of characters (FIG. 30C) are skipped during reproduction of a movie.

The recording operation activated by operating the release button C0P01 while the apparatus is in the video recording standby state or while movie-video recording is not performed in simultaneous shooting mode (P_{M}) is the same as the recording operation in silver salt shooting mode (P_{H}). Recording performed during shooting has been described hereinbefore.

Hereinafter, a description will be given as to reproduction and editing. The state in which some shooting has been performed in the set state is hereinafter referred to as “the shooting state”. In this shooting state, when the operation mode selecting switch C0P09 is set to the video reproduction mode (V) position, the camera microcomputer C01 sets operation buttons ready for the video reproduction mode (V).

In this set state, a press of the rewind button C0P30 rewinds the videocassette tape serving as the recording medium C28, a press of the stop button C0P33 stops rewinding, and thereafter, a press of the playback button C0P31 starts reproduction. The image signal recorded on the recording medium C28 and the shooting information recorded in the data area b are read out by the head C26, decoded by the recording/reproduction converter C25, processed by the image processor C24, and then displayed in the EVF unit C27. Here, the display in the EVF unit C27 is performed according to the shooting information recorded in the data area of the recording medium C28 in the following manner.

1) If no information is available as to still shooting, an ordinary video is reproduced.

2) If information is available as to still shooting, and a movie is not being shot, a still image is reproduced. For example, screens as shown in FIGS. 30A to 30C are displayed for approximately fifteen seconds.

3) If information is available as to still shooting, and a movie is being shot, an ordinary video is reproduced. However, a shutter sound accompanying shooting is not suppressed but kept alive. Alternatively, a still image is reproduced as in 2) above.

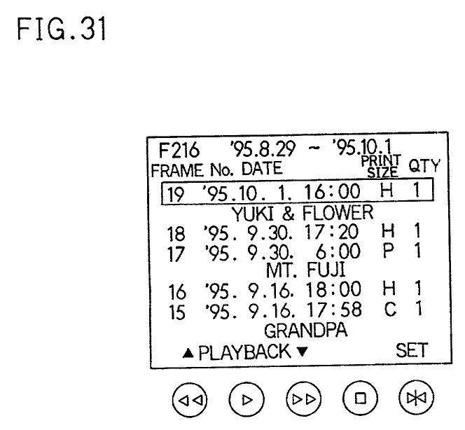

In the shooting state, when the operation mode selecting switch C0P09 is set to the edit mode (E) position, the camera microcomputer C01 sets operation buttons ready for the edit mode (E). Simultaneously, the control unit C01D reads out the shooting information as to the loaded film C08 recorded in the memory C01E in the camera microcomputer C01, transmits the information to the image processor C24, and displays the information as index information in EVF C27 as shown in FIG. 31. As index information, shooting information of each frame is displayed together with the period from the first frame to the last frame of the film C08.

In this state, when the playback button C0P31 is pressed, the camera microcomputer C01 instructs the recording medium driver C36 to feed the tape backward, and reproduces the data in the data area b through the head C26. In this process of reproduction, when information as to still shooting is found on the recording medium, feeding of the tape is stopped for a while so that the information of a still image and the shooting information are reproduced and displayed in the EVF unit C27. Search for information as to still shooting is realized, for example, by reproducing time codes to rewind the tape up to the same time point as the time inside the memory C01E and then reproducing data in the data area at a slow speed.

Still images are reproduced as shown in FIGS. 30A to 30C. A still image is reproduced for approximately 15 seconds and, when this predetermined time passes away, the next image is reproduced. It is possible to rewind the tape during reproduction in order to search for information of the next still image. In this case, when the stop button C0P33 is pressed during reproduction, the camera microcomputer C01 stops the search for the next still image, and continues reproducing the still image that has been reproduced until that time, simultaneously superimposing the shooting information thereupon as shown in FIG. 32A. Alternatively, an image to be edited with the fast-forward button and the rewind button in a screen as shown in FIG. 31 is first selected and is then searched for with a pause button. The searched image is displayed as shown in FIG. 32A. Items to be edited can be selected with the fast-forward button C0P32 and the rewind button C0P30.

In order to rewrite a selected item, the screen is switched to an edit screen by pressing the pause button (set) C0P34. FIG. 32B shows a state of the screen after the print aspect ratio is selected as an item to be edited and the pause button C0P34 is pressed in the screen shown in FIG. 32A. Here, the edge lines of the frames H, C and P appear on the screen. In this state, when the frame C is selected with the playback button C0P31, the display of the portions other than the frame of the print aspect ratio C changes from colored to monochrome.

Here, when the pause button C0P34 is pressed, the print aspect ratio is switched to C, the data in the memory C01E is rewritten, and the screen returns to the state shown in FIG. 32A. Simultaneously, the camera microcomputer C01 instructs the silver salt shooting section 70 to rewrite the aspect ratio of the corresponding frame, so that the film C08 is rewound up to the corresponding frame and its aspect ratio is rewritten by the silver salt shooting information recording section C37.

Operations on the screen of the EVF C27 unit are achieved by means of a silver salt information input section G. When the screen shown in FIG. 32A is displayed, a press of the playback button C0P31 reproduces the next still image. When the screen shown in FIG. 32A is displayed, a press of the stop button C0P33 returns the screen to an index screen as shown in FIG. 31. When the screen shown in FIG. 31 or FIG. 32 is displayed, switching of the operation mode selecting C0P09 from the edit mode (E) position to another position sets the camera microcomputer C01 controlling the film C08 and the recording medium C28 to be driven up to their standby positions (for example, up to the top of the unexposed portion of the film C08, and up to the top of the unrecorded portion of the recording medium C28).

If the control is left as described above, the index data of a film C08 with which shooting is finished is kept stored in the memory C01E, causing shortage of available memory. In this case, by pressing the film cartridge exchange but-ton C0P08, the memory C01E is reset to allow exchange of films C08.

However, since the above operation erases index data of a film C08 with which shooting is completed, it is necessary to create a new set of index data. The operation to achieve this will be described below. Although the following description deals with a tape-form recording medium C28, the same description is applicable to a disk-form recording medium.

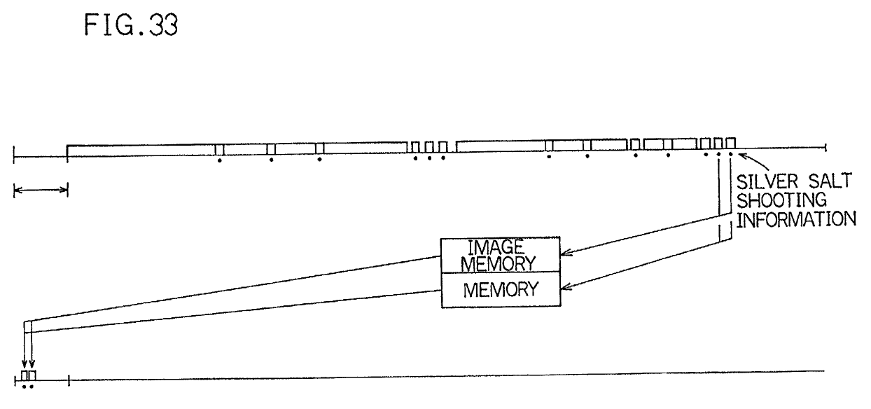

FIG. 33 shows an example of creating index data on a tape-form recording medium. As shown in the figure, an area for recording index data is provided beforehand at the top or end of the tape. Incidentally, in the case of a disk-form recording medium C28, an area 80 for recording index data is provided in the innermost or outermost portion thereof.

Under the condition that the operation mode selecting switch C0P09 is in the edit mode (E) position, when the film cartridge button C0P08 is pressed, the camera microcomputer C01 instructs the recording medium driver C36 to feed the tape backward, and reproduces the data in the data area through the head C26. In this process of reproduction in the reverse direction, when information as to still shooting is found on the recording medium, feeding of the tape is stopped for a while so that the information of a still image is reproduced in the forward direction and stored in the image memory in the image processor C24. Then, a next set of information as to still shooting is searched for and, when information as to still shooting is found, the information of a still image is stored in the image memory in the same manner as described above.

When still images are stored as described above until reaching the predetermined capacity of the image memory, the tape is driven up to its index area so that the information as to still images in the image memory and the corresponding shooting information are recorded therein. Here, the shooting information refers to that stored in the memory C01E. When the above process is repeated until the index data of the currently loaded film C08 is completely created, the film cartridges C08C can be exchanged.

Similarly, in order to exchange tapes, the deck open button C0P03 is operated with the operation mode selecting switch C0P09 set in the edit mode (E) position. Then the index data of the currently loaded film C08 is created on the tape and, thereafter, tapes can be exchanged.

What is claimed is:

1. An image shooting apparatus comprising
a silver salt picture shooting section having a silver salt picture recording function and a silver salt information recording function;
a video picture shooting section;
a video signal recording section for recording a video signal obtained by the video picture shooting section and video information on the recording medium;
a video signal reproduction section for reproducing the video signal and video information from the recording medium;
an electric display device for displaying the video picture and video information reproduced by the video signal reproduction section;
a shooting information provider for outputting various items of information as to shooting; and
an information input section for inputting the various item of information into the shooting information provider.

2. An image shooting apparatus as claimed in claim 1,
which is capable of displaying on the electric display device various items of information recorded by the silver salt picture shooting section and by the video signal recording section and various items of information to be recorded by the silver salt picture shooting section and by the video signal recording section.

3. An image shooting apparatus a claimed in claim 1,
wherein the various items of information include at least four out of individual identification number, frame number, date, time, print aspect ratio, title, number of prints, light source nature, and television display aspect ratio.

4. An image shooting apparatus as claimed in claim 1, wherein the various items of information are rewritable by means of the information input section.

5. An image shooting apparatus as claimed in claim 1,
wherein the silver salt picture shooting section is provided with a silver salt information reproducer for reproducing a silver salt information from a recording portion of a silver salt film.

6. An image shooting apparatus as claimed in claim 1,
wherein reproduction of a video signal is restricted according to information from the video information reproduction section.

7. An image shooting apparatus as claimed in claim 6,
wherein the restriction is invoked by at least one of the items of information including individual identification number, frame number, date, time, print aspect ratio, and movie recording status, and content of the restriction is to reproduce an image as a still image.

8. An image shooting apparatus, comprising:
a silver salt picture shooting section having a silver salt picture recording function and a silver salt information recording function;
a video picture shooting section;
a video signal recording section for recording a video signal obtained by the video picture shooting section and video information;
a silver salt film individual identification number/frame number provider for outputting an individual identification number and a frame number of a silver salt film used as a recording medium for the silver salt picture shooting section; and
an index data recording section provided separately from the video signal recording section for recording index data which is an aggregate of shooting information during silver salt shooting.

9. An image shooting apparatus as claimed in claim 8,
wherein the index data recording section records information created by the silver salt film individual identification number/frame number provider.

10. An image shooting apparatus claimed in claim 8,
wherein the index data recording section records various items of information other than information created by the silver salt film individual identification number/frame number provider.

11. An image shooting apparatus as claimed in claim 10,
wherein the various items of information include at least one out of date and time, print aspect ratio, title, number of prints.

12. An image shooting apparatus as claimed in claim 8,
wherein the index data recording section records information as to still images.

13. An image shooting apparatus as claimed in claim 8,
wherein a recording medium of the index data recording section is a solid-state memory.

14. An image shooting apparatus as claimed in claim 8,
wherein a recording medium of the index data recording section is a shared portion of the recording medium of the video signal recording section.

15. An image shooting apparatus as claimed in claim 8,
wherein a tape-form recording medium is used as the recording medium of the video signal recording section.

16. An image shooting apparatus as claimed in claim 15,
wherein the index data are recorded in a top or end portion of the tape-form recording medium.

17. An image shooting apparatus as claimed in claim B,
wherein a disk-form recording medium is used as the recording medium of the video signal recording section.

18. An image shooting apparatus as claimed in claim
wherein the index data are recorded in an outermost or innermost portion of the tape-form recording medium.

19. An image shooting apparatus, comprising:
a silver salt picture shooting section in including a silver salt picture recording section and a silver salt information recording section;
a video picture shooting section;
a video signal recording section for recording a video signal obtained by the video picture shooting section and video information;
a silver salt film individual identification number/frame number provider for outputting an individual identification number and a frame number of a silver salt film used as a recording medium for the silver salt picture shooting section,
wherein said silver salt information recording section records an individual identification number outputted from the silver salt film individual identification number/frame number provider onto aid silver salt film, and
wherein said video information recording section records an individual identification number and a frame number outputted from the silver salt film individual identification number/frame number provider into an image signal corresponding to said individual identification number and said frame number.

20. An image shooting apparatus as claimed in claim 19,
wherein the silver salt information recording section is capable of recording various items of information other than information outputted from the silver salt film individual identification number/frame number provider.

21. An image shooting apparatus as claimed in claim 19,
wherein the video signal recording section is capable of recording various items of information other than information outputted from the silver salt film individual identification number/frame number provider.

22. An image shooting apparatus as claimed in claim 21,
wherein the various items of information include at least two out of date and time, printing information recording location, print aspect ratio, light source nature, number of prints, title, lens focal length, aperture value, shutter speed, exposure compensation value, film ISO sensitivity, subject luminance, photometry method, television display aspect ratio.

23. An image shooting apparatus as claimed in claim 21, which is provided with a signal converter for converting the various items of information into a character signal,
wherein the various items of information converted by the signal conversion means are recorded as an image signal by the video signal recording section.

24. An image shooting apparatus as claimed in claim 19,
wherein, when silver salt picture shooting is performed while video signal recording is not in progress, the video signal recording section records a video corresponding to said silver salt picture, and records information corresponding to said silver salt picture outputted from the silver salt film individual identification number frame number provider.

25. An image shooting apparatus as claimed in claim 19,
wherein, when silver salt picture shooting is performed while video signal recording is in progress, the video signal recording section records a video corresponding to said silver salt picture, and records information corresponding to said silver salt picture outputted from the silver salt film individual identification number/frame number provider.

26. An image shooting apparatus as claimed in claim 19, further comprising:
a video recording medium individual identification number provider for outputting an individual identification number of a video recording medium,
wherein the silver salt information recording section records the individual identification number of the video recording medium outputted from the video recording medium individual identification number provider onto a corresponding silver salt picture shooting section, and records the individual identification number of the video recording medium outputted from the video recording medium individual identification number provider.
